(19) United States
(12) Patent Application Publication
(10) Pub. No.: US 2026/0261814 A1
(43) Pub. Date: Sep. 3, 2026

(54) INFORMATION PROCESSING DEVICE, INFORMATION PROCESSING METHOD, AND STORAGE MEDIUM

(71) Applicant: Sony Group Corporation, Tokyo (JP)

(72) Inventors: Tetsuya MINAKAWA, Kanagawa (JP); Nobuaki KAWAI, Kanagawa (JP); Yutaka TAKASE, Kanagawa (JP); Yasuo KAWABATA, Kanagawa (JP); Masafumi TAKAHASHI, Kanagawa (JP); Miki TOKITAKE, Tokyo (JP); Kosuke YOSHITOMI, Kanagawa (JP)

(73) Assignee: Sony Group Corporation, Tokyo (JP)

(21) Appl. No.: 18/713,427

(22) PCT Filed: Oct. 27, 2022
(86) PCT No.: PCT/JP2022/040261

§ 371 Date: May 24, 2024

(30) Foreign Application Priority Data
Dec. 2, 2021 (JP) 2021-196377

(51) Int. Cl. H04S 7/00; H04R 5/02

(52) U.S. Cl. CPC H04S 7/303; H04R 5/02; H04S 2400/11; H04S 2420/13

(57) ABSTRACT

An information processing device according to the present technology includes: a position information acquisition unit that acquires position information of a first target object in a first space in which a speaker array is arranged and position information of a second target object in a second space; a position determination processing unit that determines a virtual position of the second target object in a first fusion space obtained by virtually fusing the second space to the first space; and an output control unit that performs output control of the speaker array by applying a wavefront synthesis filter to a signal obtained by collecting a sound emitted from the second target object such that a sound image is localized at the virtual position.

### TECHNICAL FIELD

The present technology relates to an information processing device that performs output control of a speaker array for localizing a sound image, an information processing method, and a storage medium.

### BACKGROUND ART

In recent years, many proposals using a technique for beamforming have been made. For example, Patent Document 1 below discloses that superdirective sound collection is performed by performing microphone array processing on a stream group of audio signals collected by a microphone group including a plurality of microphones, and a voice (sound image) is reproduced for another user by reproducing the stream group of collected audio signals from speakers around the user in another space.

### CITATION LIST

### Patent Document

Patent Document 1: WO 2014/010290 A

### SUMMARY OF THE INVENTION

### Problems to be Solved by the Invention

However, in the configuration disclosed in Patent Document 1, there is a problem that it is necessary to arrange the microphone array and the speaker array so as to form an acoustic closed surface.

The present technology has been made in view of the above circumstances, and an object thereof is to appropriately output a sound generated in a certain space in another space.

### Solutions to Problems

An information processing device according to the present technology includes: a position information acquisition unit that acquires position information of a first target object in a first space in which a speaker array is arranged and position information of a second target object in a second space; a position determination processing unit that determines a second target object virtual position in a first fusion space obtained by virtually fusing the second space to the first space; and an output control unit that performs output control of the speaker array by applying a wavefront synthesis filter to a signal obtained by collecting a sound emitted from the second target object such that a sound image is localized at the virtual position.

As a result, the virtual position of the second target object can be determined at an appropriate position in the first fusion space according to the position of the second target object in the second space.

An information processing method according to the present technology includes an arithmetic processing device that performs: a process of acquiring position information of a first target object in a first space in which a speaker array is arranged and position information of a second target object in a second space;
a process of determining a virtual position of the second target object in a first fusion space obtained by virtually fusing the second space to the first space; and
a process of performing output control of the speaker array by applying a wavefront synthesis filter to a signal obtained by collecting a sound emitted from the second target object such that a sound image is localized at the virtual position.

A storage medium according to the present technology stores a program for causing an arithmetic processing device to perform: a process of acquiring position information of a first target object in a first space in which a speaker array is arranged and position information of a second target object in a second space; a process of determining a virtual position of the second target object in a first fusion space obtained by virtually fusing the second space to the first space; and a process of performing output control of the speaker array by applying a wavefront synthesis filter to a signal obtained by collecting a sound emitted from the second target object such that a sound image is localized at the virtual position.

As a result, the above-described information processing device can be realized.

### BRIEF DESCRIPTION OF DRAWINGS

FIG. 1 is a schematic diagram illustrating that communication can be performed between a user in a first space and a user in a second space by an audio reproduction system as the present embodiment.

FIG. 2 is a schematic diagram illustrating a state in which a first user perceives an uttered voice from a virtual second user located in a first space.

FIG. 3 is a diagram illustrating an arrangement example of a first speaker array in a first space.

FIG. 4 is a schematic diagram illustrating a configuration example of an audio reproduction system.

FIG. 5 is a block diagram illustrating a configuration example of a first information processing device.

FIG. 6 is a block diagram illustrating a configuration example of a server device.

FIG. 7 is an example of a sound reception area and a virtual sound source arrangeable area formed in the first space.

FIG. 8 is another example of the sound reception area and the virtual sound source arrangeable area formed in the first space.

FIG. 9 is still another example of the sound reception area and the virtual sound source arrangeable area formed in the first space.

FIG. 10 is another example of the sound reception area and the virtual sound source arrangeable area formed in the first space.

FIG. 11 is still another example of the sound reception area and the virtual sound source arrangeable area formed in the first space.

FIG. 12 is a diagram for explaining an outline of a flow of processing executed by each device of the first information processing device, the second information processing device, and the server device.

FIG. 13 is a flowchart illustrating an example of wavefront synthesis method selection processing.

FIG. 14 is a flowchart illustrating an example of wavefront synthesis method selection processing similarly to FIG. 13.

FIG. 15 is a schematic diagram illustrating an example of a first fusion space and a second fusion space.

FIG. 16 is a schematic diagram illustrating an example in which sizes of a first space and a second space are different.

FIG. 17 is a schematic diagram illustrating an example in which a part of a second space is fused with a first space to form a first fusion space, and the first space is fused with a part of a second space to form a second fusion space.

FIG. 18 is a schematic diagram illustrating an example in which a second space is compressed and fused to a first space to form a first fusion space.

FIG. 19 is a schematic diagram illustrating an example in which a first space is expanded and fused to a second space to form a second fusion space.

FIG. 20 is a schematic diagram illustrating a positional relationship between two first users in a first space.

FIG. 21 is a schematic diagram illustrating a positional relationship between two second users in a second space.

FIG. 22 is a schematic diagram illustrating a first fusion space before position correction is performed.

FIG. 23 is a schematic diagram illustrating a second fusion space before position correction is performed.

FIG. 24 is a schematic diagram illustrating a first fusion space after using a first method of position correction.

FIG. 25 is a schematic diagram illustrating a second fusion space after using a first method of position correction.

FIG. 26 is a schematic diagram illustrating a first fusion space after using a second method of position correction.

FIG. 27 is a schematic diagram illustrating a second fusion space after using a second method of position correction.

FIG. 28 is a schematic diagram illustrating a first space before using a third method of position correction.

FIG. 29 is a schematic diagram illustrating a second space before using a third method of position correction.

FIG. 30 is a schematic diagram illustrating a first fusion space after using a third method of position correction.

FIG. 31 is a schematic diagram illustrating a second fusion space after using a third method of position correction.

FIG. 32 is a diagram illustrating an example of an application screen for the user to arbitrarily determine the position of the virtual sound source.

FIG. 33 is a speaker array arranged in a first space according to a second embodiment.

FIG. 34 is an example of a sound reception area and a virtual sound source arrangeable area formed in a first space in the second embodiment.

FIG. 35 is another example of the sound reception area and the virtual sound source arrangeable area formed in the first space in the second embodiment.

FIG. 36 is still another example of the sound reception area and the virtual sound source arrangeable area formed in the first space in the second embodiment.

FIG. 37 is another example of the sound reception area and the virtual sound source arrangeable area formed in the first space in the second embodiment.

FIG. 38 is a diagram illustrating an example of a unit device.

FIG. 39 is a diagram illustrating an example of a first lower speaker array including a plurality of speaker units.

FIG. 40 is a diagram illustrating a configuration of a speaker unit.

FIG. 41 is a diagram illustrating another example of the unit device.

FIG. 42 is a diagram illustrating still another example of the unit device.

FIG. 43 is a diagram illustrating another example of the unit device.

### MODE FOR CARRYING OUT THE INVENTION

Hereinafter, embodiments according to the present technology will be described in the following order with reference to the accompanying drawings.
<1. Outline of Audio Reproduction System>
<2. Configuration of Audio Reproduction System>
<3. Relationship Between Virtual Sound Source Position and Sound Reception Position>
<4. Processing Example>
<5. Correction of Space Size>
<6. Correction Processing for Arrangement of Virtual Sound Source>
<7. Second Embodiment>
<8. Specific Examples>
<9. Modifications>
<10. Conclusion>
<11. Present Technology>

### 1. Outline of Audio Reproduction System

First, an outline of an audio reproduction system 1 according to the present embodiment will be described.

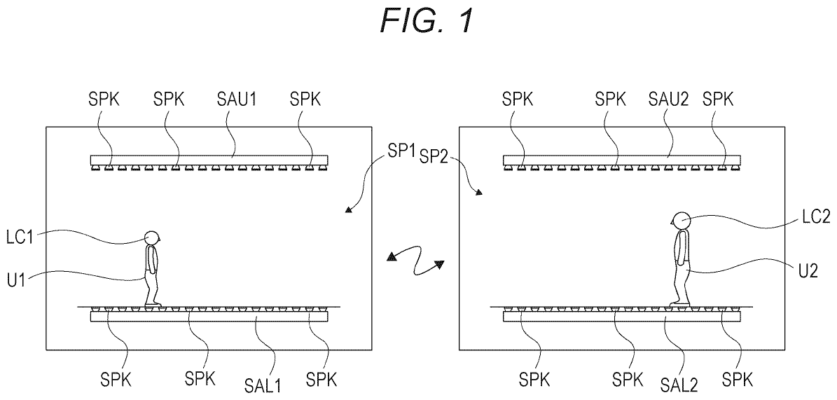

As illustrated in FIG. 1, the audio reproduction system 1 is used to communicate between users located in each of a first space SP1 and a second space SP2 located at distant positions.

In the first space SP1, a first upper speaker array SAU1 is arranged above and a first lower speaker array SAL1 is arranged below. A first user U1 is located between the first upper speaker array SAU1 and the first lower speaker array SAL1. Specifically, the first user U1 is located in a standing state on a floor disposed above the first lower speaker array SAL1.

Note that, in a case where the first upper speaker array SAU1 and the first lower speaker array SAL1 are not distinguished from each other, they are simply referred to as a first speaker array SA1.

In the second space SP2, a second upper speaker array SAU2 is arranged above and a second lower speaker array SAL2 is arranged below. A second user U2 is located between the second upper speaker array SAU2 and the second lower speaker array SAL2. Specifically, the second user U2 is located in a standing state on a floor disposed above the second lower speaker array SAL2.

Note that, in a case where the second upper speaker array SAU2 and the second lower speaker array SAL2 are not distinguished from each other, they are simply referred to as a second speaker array SA2.

A camera, a microphone, a human sensor, and the like (not illustrated) are arranged in the first space SP1, and the position of the first user U1 can be specified on the basis of sensing data obtained by the camera, the microphone, the human sensor, and the like.

In addition, the microphone arranged in the first space SP1 collects the uttered voice by the first user U1 located in the first space SP1, the environmental sound that can be heard in the first space SP1, and the like.

A camera, a microphone, a human sensor, and the like (not illustrated) are arranged in the second space SP2, and the position of the second user U2 can be specified on the basis of sensing data obtained by the camera, the microphone, the human sensor, and the like.

In addition, the microphone arranged in the second space SP2 collects the uttered voice of the second user U2 located in the second space SP2, the environmental sound that can be heard in the second space SP2, and the like.

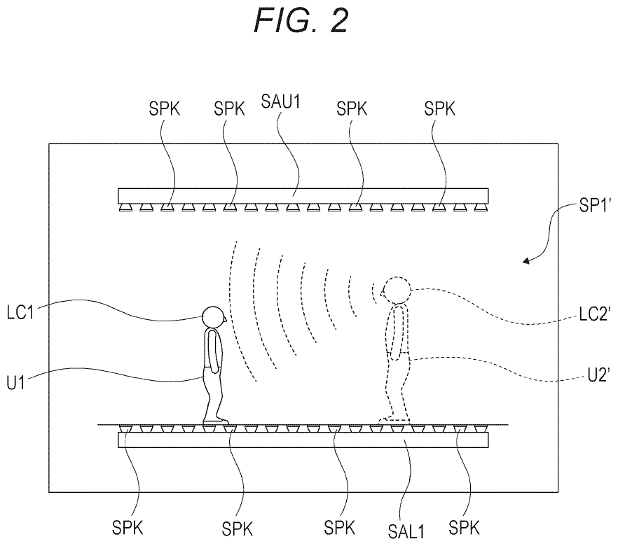

In the first space SP1, as illustrated in FIG. 2, a first fusion space SP1′ in which the first space SP1 and the second space SP2 are fused is realized.

In the first fusion space SP1′, a second virtual sound source position LC2′ for localizing the sound image of the uttered voice of the second user U2 is set on the basis of the second user position LC2 specified as the position of the second user U2 detected in the second space SP2.

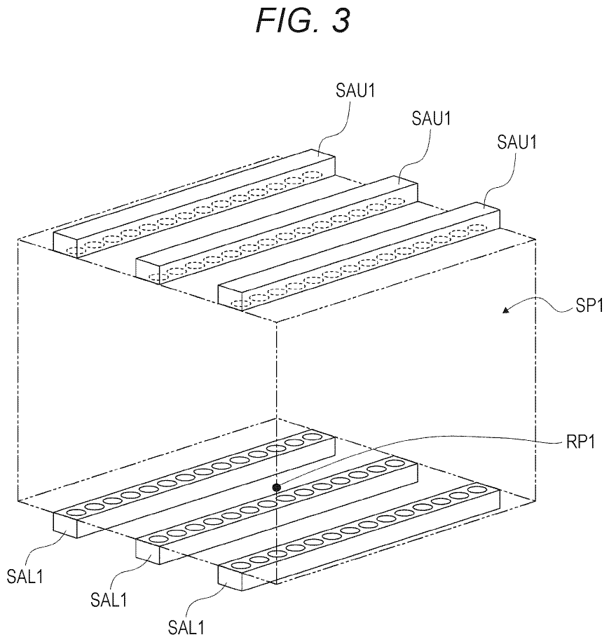

For example, the coordinates of the first user position LC1 are determined on the basis of the relative position with respect to the first reference position RP1 (see FIG. 3) set in the first space SP1.

In addition, the coordinates of the second user position LC2 are determined on the basis of the relative position with respect to the second reference position RP2 similarly set in the second space SP2.

For example, the first reference position RP1 is set at a position where a perpendicular line crosses the floor surface when the perpendicular line is drawn down from the center coordinate of the first space SP1 to the floor surface.

Similarly, the second reference position RP2 is set, for example, at a position where a perpendicular line crosses the floor surface when the perpendicular line is drawn down from the center coordinate of the second space SP2 to the floor surface.

Then, in the first fusion space SP1′, the second virtual sound source position LC2′ is determined such that the positional relationship between the first reference position RP1 and the second virtual sound source position LC2′ coincides with the positional relationship between the second reference position RP2 and the second user position LC2 in the second space SP2.

The coordinates of the first virtual sound source position LC1′ in the second fusion space SP2′ are similarly determined.

In the first fusion space SP1′, the acoustic output by the first upper speaker array SAU1 and the first lower speaker array SAL1 is performed so that the sound image of the uttered voice of the second user U2 acquired in the second space SP2 is localized at the second virtual sound source position LC2′.

At this time, appropriate wavefront synthesis control is performed on the voice output from the first upper speaker array SAU1 and the first lower speaker array SAL1, so that the first user U1 can perceive the voice as if the voice was uttered by the virtual second user U2 (the virtual second user U2′ indicated by a broken line in FIG. 2).

Even in a case where the uttered voice of the first user U1 is reproduced in the second fusion space SP2′ obtained by virtually fusing the first space SP1 to the second space SP2, similar processing is performed, so that the second user U2 can perceive the uttered voice of the first user U1 as if the uttered voice was uttered by the virtual first user U1′ in front of the second user U2.

Note that, in the first space SP1 in FIGS. 1 and 2, the plurality of first upper speaker arrays SAU1 may be arranged such that the respective speakers SPK included in the first upper speaker array SAU1 are two-dimensionally arranged on a horizontal plane (see FIG. 3).

Similarly, the plurality of first lower speaker arrays SAL1 may be arranged such that the respective speakers SPK included in the first lower speaker array SAL1 are two-dimensionally arranged on the horizontal plane.

It similarly applies to the second upper speaker array SAU2 and the second lower speaker array SAL2 in the second space SP2.

### 2. Configuration of Audio Reproduction System

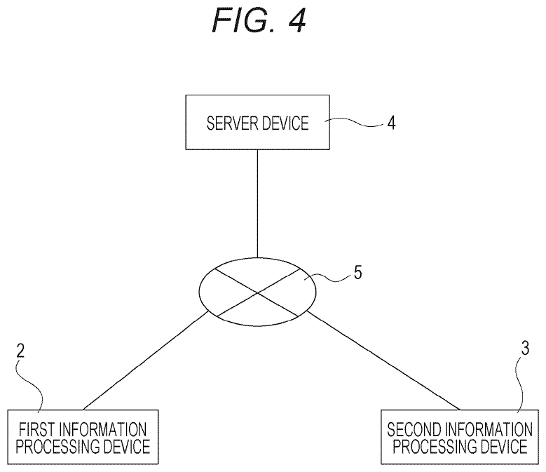

A configuration example of the audio reproduction system 1 will be described with reference to FIG. 4.

The audio reproduction system 1 includes a first information processing device 2, a second information processing device 3, a server device 4, and a communication network 5 to which the first information processing device 2, the second information processing device 3, and the server device 4 are connected.

The first information processing device 2 includes a central processing unit (CPU), a read only memory (ROM), a random access memory (RAM), and the like, and receives sensing data from various sensing devices 6 connected to the first information processing device 2.

The various sensing devices 6 are a microphone, a camera, a distance measuring device, a human sensor, and the like, and may include a mobile terminal (such as a smartphone) worn by the first user U1 and having a function of detecting position information. Note that the sensing device 6 may be a distance measuring device or a positioning device that can acquire coordinates in a three-dimensional space.

As the distance measuring device, various devices such as a device using a time of flight (ToF) method, a radar using millimeter waves, and a device using ultra-wide band (UWB) can be considered. Furthermore, the camera may have a function as a distance measuring device.

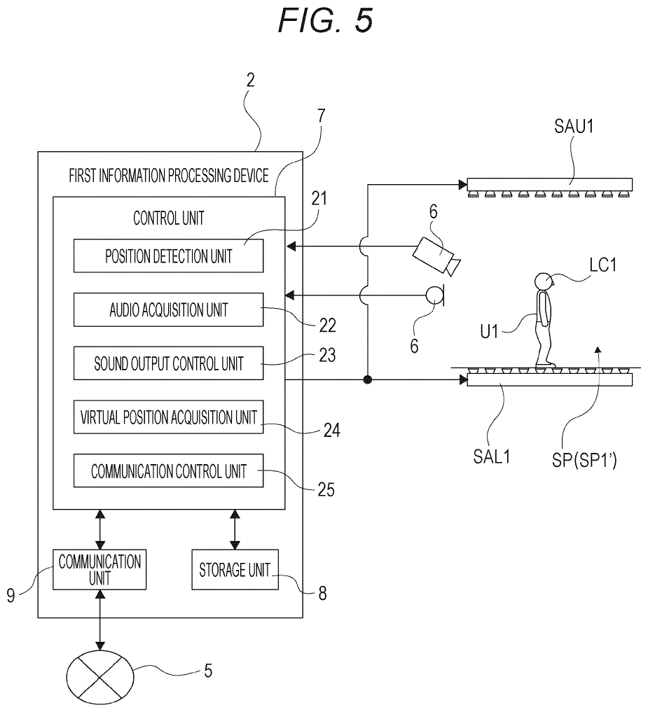

A specific configuration example of the first information processing device 2 is illustrated in FIG. 5.

The first information processing device 2 includes a control unit 7, a storage unit 8, and a communication unit 9.

The control unit 7 can communicate with the sensing device 6, the first upper speaker array SAU1, and the first lower speaker array SAL1.

The control unit 7 has functions as a position detection unit 21, an audio acquisition unit 22, a sound output control unit 23, a virtual position acquisition unit 24, and a communication control unit 25.

The position detection unit 21 receives the sensing data from the sensing device 6, and detects the position of the first target object located in the first space SP1, that is, the position of the head of the first user U1 in the present embodiment, as the first user position LC1. The detected first user position LC1 is uploaded to the server device 4 via the communication network 5 by processing of the communication control unit 25.

Note that the detected first user position LC1 is uploaded to the server device 4 in association with the acoustic information of the uttered voice of the first user U1.

The audio acquisition unit 22 acquires acoustic information generated in the second space SP2. Specifically, the audio acquisition unit 22 acquires, via the communication network 5, the acoustic information of the uttered voice of the second user U2 uploaded from the second information processing device 3 that acquires the sensing data for the second space SP2 to the server device 4.

Note that the first information processing device 2 also acquires the second user position LC2 for the second user U2 associated with the acoustic information of the uttered voice of the second user U2.

The sound output control unit 23 transmits an acoustic signal to each speaker SPK (for example, a point sound source speaker) included in the first upper speaker array SAU1 and the first lower speaker array SAL1 arranged in the first space SP1. When each speaker SPK performs reproduction processing based on the acoustic signal, predetermined wavefront synthesis is performed in the first space SP1, and a desired sound field is realized.

Therefore, the sound output control unit 23 performs various types of signal processing for each acoustic signal output to each speaker SPK. For example, the sound output control unit 23 performs processing of applying a predetermined filter according to the second virtual sound source position LC2′ such as the position of the mouth of the virtual second user U2′, thereby implementing wavefront synthesis in which the sound image is localized at the mouth.

In addition, the sound output control unit 23 performs processing of applying a filter selected according to the relationship between the second virtual sound source position LC2′ and the first user position LC1, that is, the relationship between the position of the mouth (head) of the virtual second user and the position of the ear (head) of the first user U1.

Alternatively, the sound output control unit 23 performs processing of applying a filter selected according to the positional relationship between the first user position LC1 and the first speaker array SA1.

Furthermore, the sound output control unit 23 performs seamless processing for coping with a change in a filter to be applied and a variation in each position. In the seamless processing, for example, fade processing or the like is performed.

Each filter applied by the sound output control unit 23 is determined, for example, in the server device 4.

The virtual position acquisition unit 24 acquires the second user position LC2 or the position of the virtual second user U2′.

As described above, the second user position LC2 is determined according to the relative positional relationship with the second reference position RP2. Furthermore, the position of the virtual second user U2′, that is, the second virtual sound source position LC2′ is a position in the first fusion space SP1′ determined on the basis of the position of the second user U2 in the second space SP2.

These pieces of position information are calculated by the server device 4, for example.

The second virtual sound source position LC2′ acquired by the virtual position acquisition unit 24 may be used, for example, when projecting a hologram video based on a captured image of the second user U2 or the like.

The communication control unit 25 performs processing of uploading the above-described various types of information to the server device 4, processing of downloading various types of information from the server device 4, and the like. Note that the communication control unit 25 may perform processing of transmitting the space size of the first space SP1 used for correcting the space size to be described later.

The storage unit 8 stores information on the absolute position or the relative position of the first speaker array SA1. In addition, the storage unit 8 stores position information of each speaker SPK included in the first speaker array SA1.

The communication unit 9 performs communication according to processing of the communication control unit 25.

The description returns to FIG. 4.

The second information processing device 3 can have a configuration similar to that of the first information processing device 2 including a CPU, a ROM, a RAM, and the like. The second information processing device 3 receives sensing data from various sensing devices 6 connected to the second information processing device 3.

Since the configuration of the second information processing device 3 is similar to the configuration of the first information processing device 2, the description thereof will be omitted. The second information processing device 3 performs processing similar to that of the first information processing device 2 for the second speaker array SA2 and the second user U2.

As a result, the second information processing device 3 can realize a desired sound field in the second space SP2 (or the second fusion space SP2′) by uploading various types of information and data regarding the uttered voice of the second user U2 to the server device 4 and transmitting an acoustic signal to the second speaker array SA2 arranged in the second space SP2.

The server device 4 includes a CPU, a ROM, a RAM, and the like, acquires information of the first user position LC1 and information of the second user position LC2 from the first information processing device 2 and the second information processing device 3, and determines the first virtual sound source position LC1′ and the second virtual sound source position LC2′ according to the information.

In addition, the server device 4 performs processing of determining characteristics (hereinafter, described as “filter characteristic”) of a filter to be applied by the first information processing device 2 or the second information processing device 3 to perform predetermined wavefront synthesis on the basis of each piece of position information.

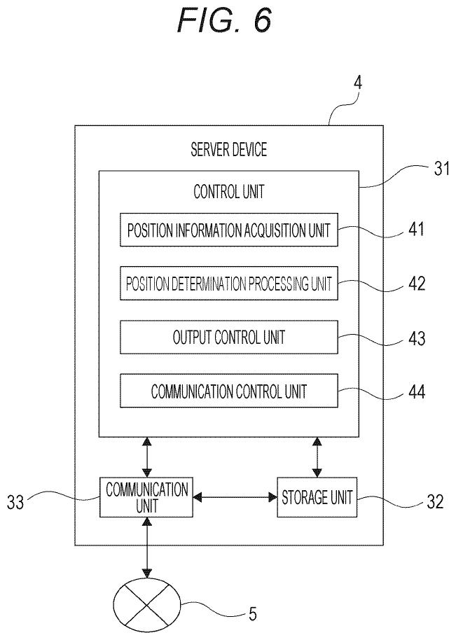

A specific configuration example of the server device 4 is illustrated in FIG. 6.

The server device 4 includes a control unit 31, a storage unit 32, and a communication unit 33.

The control unit 31 has functions as a position information acquisition unit 41, a position determination processing unit 42, an output control unit 43, and a communication control unit 44.

The position information acquisition unit 41 acquires the information of the first user position LC1, the position information of the first speaker array SA1, the position information of each speaker SPK included in the first speaker array SA1, and the like from the first information processing device 2.

In addition, the position information acquisition unit 41 acquires the information of the second user position LC2, the position information of the second speaker array SA2, the position information of each speaker SPK included in the second speaker array SA2, and the like from the second information processing device 3.

The position determination processing unit 42 determines the second virtual sound source position LC2′ in the first fusion space SP1′ on the basis of the information of the second user position LC2. The determined second virtual sound source position LC2′ is transmitted to the first information processing device 2.

The position determination processing unit 42 determines the first virtual sound source position LC1′ in the second fusion space SP2′ on the basis of the information of the first user position LC1. The determined first virtual sound source position LC1′ is transmitted to the second information processing device 3.

The output control unit 43 determines a filter characteristic to be applied to the acoustic signal to be transmitted to each speaker SPK on the basis of the position information of the first speaker array SA1 in the first space SP1 (or the first fusion space SP1′), the position information of each speaker SPK included in the first speaker array SA1, the information of the first user position LC1, and the information of the second virtual sound source position LC2′ of the virtual second user U2′.

The determined filter characteristic is transmitted to the first information processing device 2.

Similarly, the output control unit 43 determines a filter characteristic to be applied to the acoustic signal to be transmitted to each speaker SPK on the basis of the position information of the second speaker array SA2 in the second space SP2 (or the second fusion space SP2′), the position information of each speaker SPK included in the second speaker array SA2, the information of the second user position LC2, and the information of the first virtual sound source position LC1′ of the virtual first user U1′.

The determined filter characteristic is transmitted to the second information processing device 3.

The communication control unit 44 performs processing of transmitting the above-described various types of information to the first information processing device 2 and the second information processing device 3, processing of acquiring information from the first information processing device 2 and the second information processing device 3, and the like.

The storage unit 32 stores each piece of position information received from the first information processing device 2 or the second information processing device 3 and the like.

The communication unit 33 performs communication according to processing of the communication control unit 44.

### <3. Relationship Between Virtual Sound Source Position and Sound Reception Position

An area in which the virtual sound source can be arranged and an area in which appropriate sound reception can be performed are determined by the filter characteristic for wavefront synthesis selected by the output control unit 43 of the server device 4. The area in which appropriate sound reception is possible is an area in which localization of a sound image of a virtual sound source can be perceived as expected. An area in which the virtual sound source can be arranged is described as a “virtual sound source arrangeable area ARP”, and an area in which appropriate sound reception is possible is described as a “sound reception area ARH”. The sound reception area ARH can be rephrased as a sound image localization service area.

In the above example, in order for the first user U1 to listen to the uttered voice of the second user U2 from an appropriate direction, it is required that the first user position LC1 (the head position of the first user U1) is included in the sound reception area ARH and the second virtual sound source position LC2′ for the second user U2 is included in the virtual sound source arrangeable area ARP.

Therefore, the output control unit 43 of the server device 4 selects an appropriate filter characteristic for wavefront synthesis in consideration of the first user position LC1, the second virtual sound source position LC2′, the position of the first speaker array SA1, and the position of each speaker SPK.

Note that the virtual sound source arrangeable area ARP and the sound reception area ARH are different depending on the filter characteristics for wavefront synthesis. Formation examples of the virtual sound source arrangeable area ARP and the sound reception area ARH are illustrated in the respective drawings. Note that the first space SP1 is taken as an example. In addition, as the virtual sound source arranged in the first space SP1, an uttered voice of the virtual second user U2′ is taken as an example.

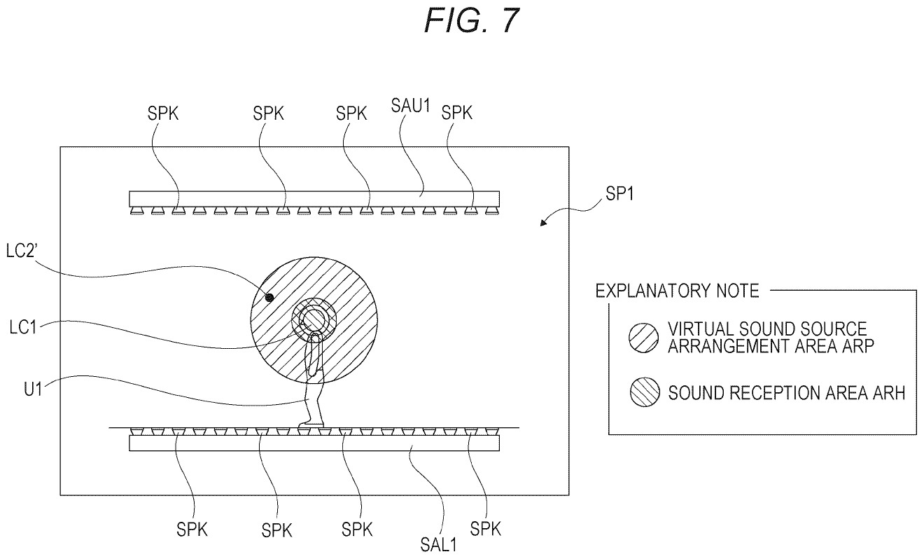

FIG. 7 illustrates a formation example of the virtual sound source arrangeable area ARP and the sound reception area ARH in a case where a filter based on mode matching is selected as a filter for wavefront synthesis.

As illustrated, the head of the first user U1 is located substantially at the center of the first space SP1, and the sound reception area ARH is formed in a spherical shape so as to include the head. In addition, the virtual sound source arrangeable area ARP is formed in a spherical shape extending outside the sound reception area ARH.

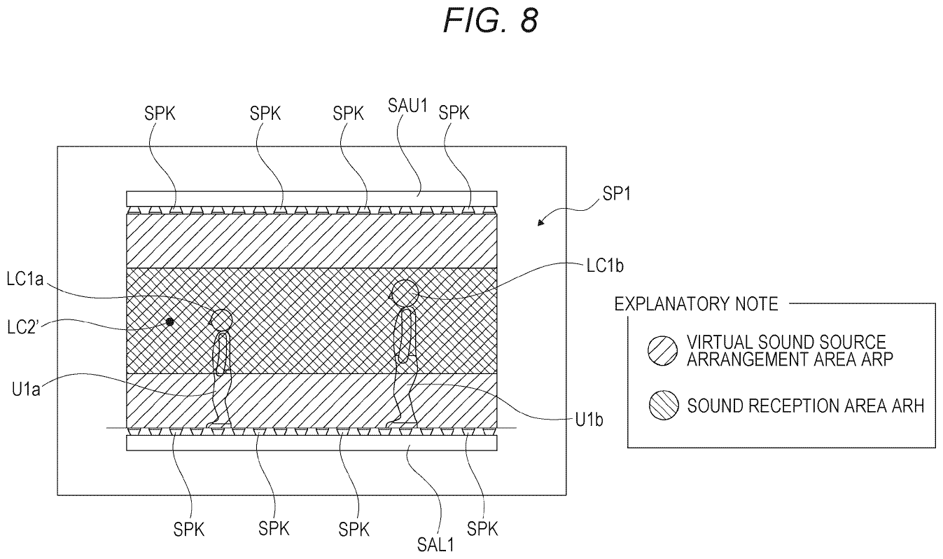

FIGS. 8, 9, 10, and 11 illustrate formation examples of the virtual sound source arrangeable area ARP and the sound reception area ARH in a case where a filter by a spectral division method (SDM) is selected as a filter for wavefront synthesis.

In the example illustrated in FIG. 8, two users (first users U1a and U1b) in a standing state are located in the first space SP1. In order to cause the two users to appropriately perceive the sound image of the virtual sound source, the sound reception area ARH is formed to spread horizontally with a certain vertical width. The reason why the sound reception area ARH has a horizontally spreading shape is that a plurality of first upper speaker arrays SAU1 and a plurality of first lower speaker arrays SAL1 are arranged so that the respective speakers SPK are two-dimensionally arranged on a horizontal plane as illustrated in FIG. 3.

In addition, in the example illustrated in FIG. 8, the virtual sound source arrangeable area ARP is formed as a space between the first upper speaker array SAU1 and the first lower speaker array SAL1, that is, an area spreading to the extent of the first space SP1.

However, the virtual sound source arrangeable area ARP may be an area including a space larger than the first space SP1. Specifically, the virtual sound source arrangeable area ARP may be an area horizontally wider than the first space SP1. In addition, the virtual sound source arrangeable area ARP may include a space above the first upper speaker array SAU1 or a space below the first lower speaker array SAL1.

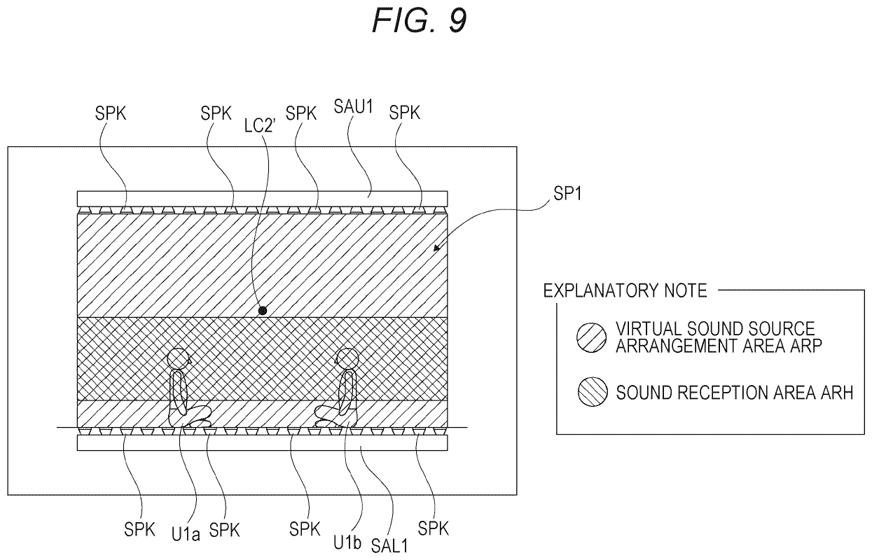

In the example illustrated in FIG. 9, two users (first users U1a and U1b) in a sitting state face each other in the first space SP1. That is, the head of the user is located below the first space SP1.

According to the filter characteristic selected to provide an appropriate sound field to each first user U1 in such a state, the sound reception area ARH is formed to spread horizontally at a position slightly below the center of the first space SP1. In addition, the virtual sound source arrangeable area ARP is formed in an area between the first upper speaker array SAU1 and the first lower speaker array SAL1.

Here, a case where the speaker array is arranged as in the related art such that the positional relationship between the two first users U1a and U1b and the virtual sound source is as illustrated in FIG. 9, that is, a case where the speaker array is arranged so as to surround the front, rear, left, and right of the first users U1a and U1b will be considered. In the conventional arrangement, the first user U1b cannot perceive the sound image of the virtual sound source at the intended position (second virtual sound source position LC2′) because occlusion occurs in which the sound from the front speaker array important for perceiving that the sound image of the virtual sound source is located in front, that is, the speaker array arranged on the back side of the first user U1a is attenuated due to the presence of the first user U1a. In particular, occlusion occurs more significantly in a case where the front speaker array and the first user U1a are linearly covered when viewed from the first user U1b.

However, as in the present embodiment, by arranging the speaker arrays above and below the head of the first user U1, it is possible to cause the sound image of the virtual sound source to be perceived at an intended position without causing occlusion even in the positional relationship illustrated in FIG. 9.

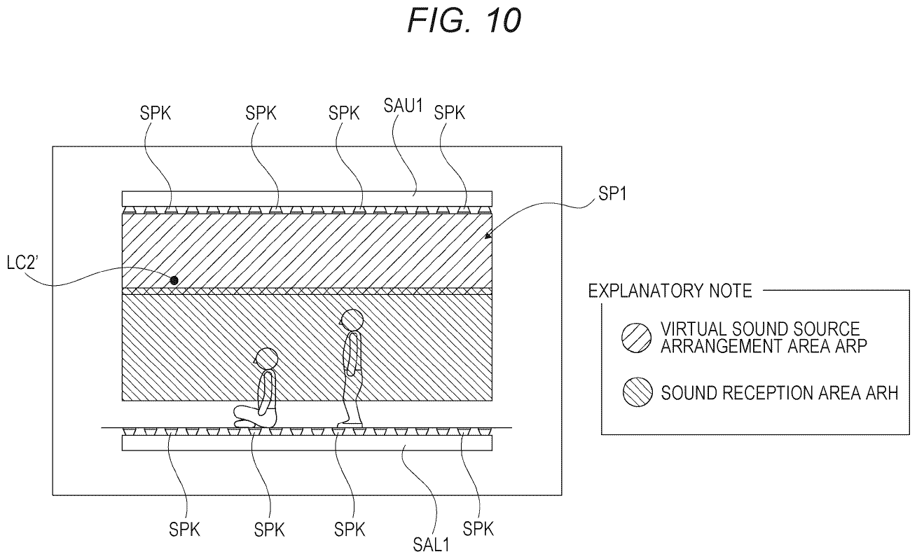

In the example illustrated in FIG. 10, the user (first user U1a) in the sitting state and the user (first user U1b) in the standing state are located in the first space SP1. In order to provide an appropriate sound field to each first user U1 in such a state, the sound reception area ARH is only required to be formed so as to include the two heads. Alternatively, the sound reception area ARH may be formed so as to include the average height positions of the two heads. In addition, the sound reception area ARH may be formed so as to include the average positions (average coordinates) of the two heads.

In addition, in the example illustrated in FIG. 10, an area above the center of the first space SP1 is formed as the virtual sound source arrangeable area ARP.

As a result, the two first users U1a and U1b can perceive the sound image of the virtual sound source localized upward.

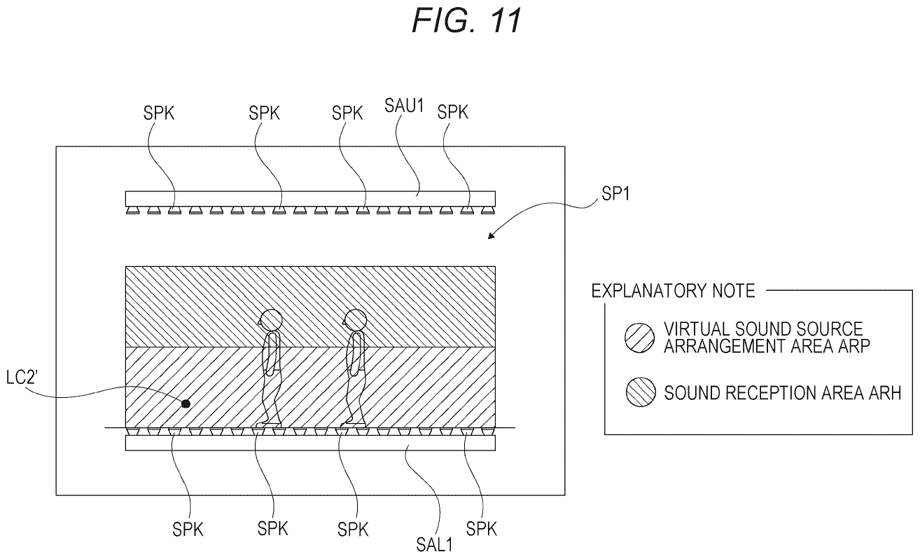

In the example illustrated in FIG. 11, two users (first users U1a and U1b) in a standing state are located in the first space SP1. In order to cause the two users to appropriately perceive the virtual sound source localized downward, the sound reception area ARH is formed in a space slightly above the first space SP1. In addition, the virtual sound source arrangeable area ARP is formed in the lower space in the first space.

As a result, the two first users U1a and U1b can perceive the sound image of the virtual sound source localized downward.

### 4. Processing Example

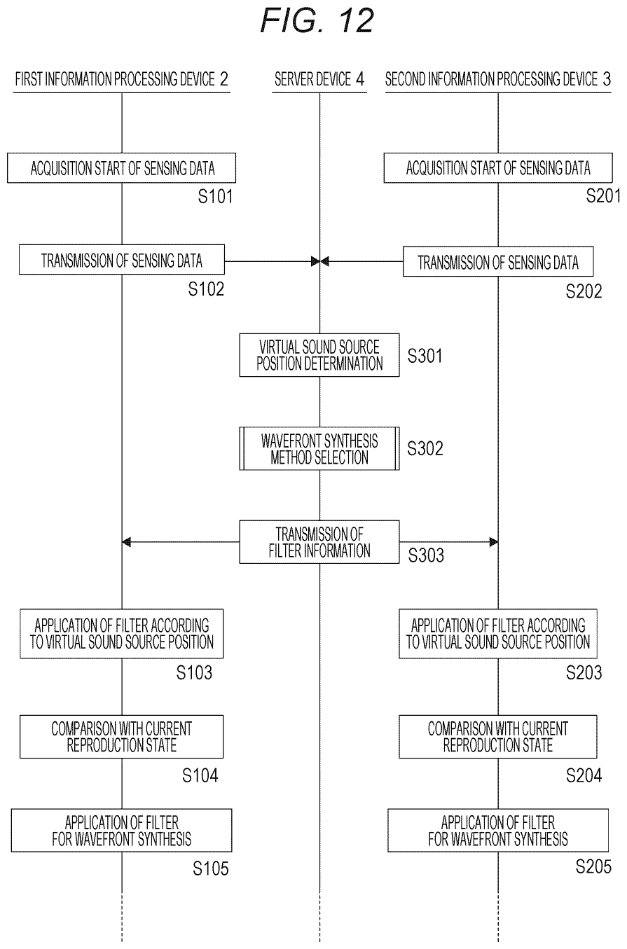

A flow of processing executed by each device to form the virtual sound source arrangeable area ARP and the sound reception area ARH at arbitrary positions as described above will be described with reference to FIG. 12.

In step S101, the control unit 31 (CPU or the like) of the first information processing device 2 starts acquisition of sensing data for the first space SP1. As a result, operations of various sensing devices 6 such as a camera and a microphone are started, and sensing data is transmitted to the first information processing device 2.

Similarly, the control unit 31 (CPU or the like) of the second information processing device 3 starts acquisition of sensing data for the second space SP2 in step S201. As a result, sensing data is transmitted from various sensing devices 6 such as a camera and a microphone to the second information processing device 3.

The control unit 31 of the first information processing device 2 transmits sensing data to the server device 4 in step S102, and the control unit 31 of the second information processing device 3 transmits sensing data to the server device 4 in step S202. Note that the processing in steps S102 and S202 is intermittently performed. As a result, the server device 4 can track the positions of the first user U1 in the first space SP1 and the second user U2 in the second space SP2.

Note that, although not illustrated, the control unit 7 of the server device 4 has already acquired the information on the position of the first speaker array SAI and the position of each speaker SPK in the first space SP1, and the information on the position of the second speaker array SA2 and the position of each speaker SPK in the second space SP2.

In step S301, the control unit 7 of the server device 4 determines the position of the virtual sound source. Specifically, the second virtual sound source position LC2′ arranged in the first space SP1 is determined on the basis of the position (second user position LC2) of the second user U2 in the second space SP2. In addition, the first virtual sound source position LC1′ arranged in the second space SP2 is determined on the basis of the position (first user position LC1) of the first user U1 in the first space SP1.

Note that there is a case where interference between the positions of the user and the virtual sound source occurs. The processing in that case will be described later again.

In step S302, the control unit 7 of the server device 4 selects a wavefront synthesis method. This processing is processing for appropriately setting the virtual sound source arrangeable area ARP and the sound reception area ARH in each space by appropriately selecting the filter characteristics for wavefront synthesis as described above. Details of the contents of the processing will be described later.

The filter characteristic for the wavefront synthesis is selected by selecting the wavefront synthesis method in step S302.

In step S303, the control unit 7 of the server device 4 transmits information on the filter characteristics.

In step S103, the control unit 31 of the first information processing device 2 that has received the information on the filter characteristics applies the filter according to the virtual sound source position (second virtual sound source position LC2′). Specifically, as will be described later, a high-pass filter (HPF), a low-pass filter (LPF), or the like is used according to the positional relationship between the head of the first user U1 and the virtual sound source.

Subsequently, in step S104, the control unit 31 of the first information processing device 2 compares the current reproduction state with the reproduction state after the new application of the filter for wavefront synthesis. In other words, it is confirmed how the sound field of the first space SP1 changes before and after a filter for wavefront synthesis is newly applied.

Next, in step S105, the control unit 31 of the first information processing device 2 applies a filter for wavefront synthesis. At this time, the seamless processing is appropriately performed according to the comparison result of step S104. In the seamless processing, for example, fade processing or the like is performed. As a result, the sound field presented to the first user U1 existing in the first space SP1 is prevented from rapidly changing.

The control unit 31 of the second information processing device 3 that has received the information on the filter characteristics transmitted in step S303 performs processing similar to that in steps S103, S104, and S105 in the first information processing device 2 in steps S203, S204, and S205.

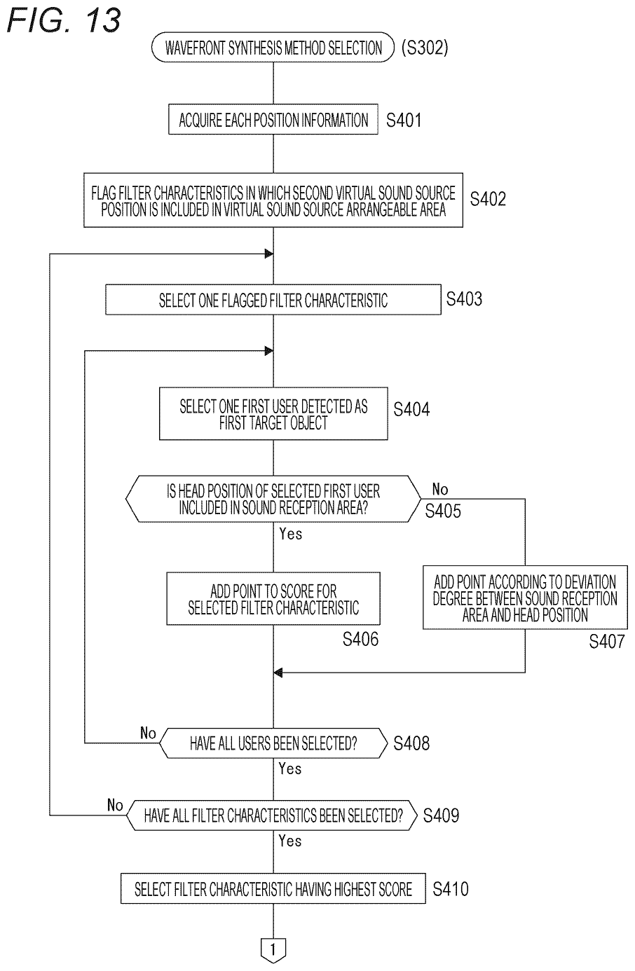

Details of the processing of step S302 executed by the control unit 7 of the server device 4 will be described with reference to FIGS. 13 and 14. Note that, in the following description, processing for the first space SP1 will be described as an example.

In step S401, the control unit 7 of the server device 4 acquires each piece of position information.

The position information includes the positions (head positions) of the first user U1 and the second user U2 existing in the first space SP1 and the second space SP2, the position of the first speaker array SA1, the position of each speaker SPK included in the first speaker array SA1, the second virtual sound source position LC2′ determined in step S301 described above, and the like.

In step S402, the control unit 7 of the server device 4 flags the filter characteristics in which the second virtual sound source position LC2′ is included in the virtual sound source arrangeable area ARP. This processing is performed for all the prepared filter characteristics. Here, the filter characteristic to which no flag is given is excluded from the selection target in the selection processing (processing of step S410) to be described later.

In step S403, the control unit 7 of the server device 4 selects one flagged filter characteristic.

In step S404, the control unit 7 of the server device 4 selects one first user U1 detected as the first target object.

In step S405, the control unit 7 of the server device 4 determines whether or not the head position (first user position LC1) of the selected first user U1 is included in the sound reception area ARH.

In a case where it is determined that the head position of the first user U1 is included in the sound reception area ARH, the control unit 7 of the server device 4 adds a point to the score for the selected filter characteristic in step S406. The score to be added at this time is the maximum value of the points to be added (for example, 10 points).

On the other hand, in a case where it is determined that the head position of the first user U1 is not included in the sound reception area ARH, the control unit 7 of the server device 4 adds a point according to the deviation degree between the sound reception area ARH and the head position in step S407. Specifically, a larger value is added as the deviation between the sound reception area ARH and the head position is smaller, and the maximum value thereof is set to 9 points, for example.

In step S408, the control unit 7 of the server device 4 determines whether or not the selection processing of step S404 has been executed for all the first users U1 existing in the first space SP1.

In a case where there is an unselected first user U1, the control unit 7 of the server device 4 returns to the processing of step S404 again, selects the unselected first user U1, and executes the subsequent processing.

On the other hand, in a case where there is no unselected first user U1, the scoring for one filter characteristic selected in step S403 is completed. In this case, in step S409, the control unit 7 of the server device 4 determines whether or not all the flagged filter characteristics have been selected, that is, whether or not scoring has been completed for all the flagged filter characteristics.

In a case where there is a filter characteristic that has not been selected, that is, in a case where there remains a filter characteristic for which scoring has not been completed, the control unit 7 of the server device 4 returns to step S403 again, selects an unselected filter characteristic, and then performs each processing in the subsequent stage.

On the other hand, in a case where it is determined that all the flagged filter characteristics have been selected, that is, in a case where it is determined that scoring has been completed for all the flagged filter characteristics, the control unit 7 of the server device 4 selects a filter characteristic having the highest score in step S410.

Note that, in a case where the scores are the same, filter characteristics included in the sound reception area ARH and having the largest number of users may be selected, or filter characteristics having the largest virtual sound source arrangeable area ARP may be selected.

In step S411 in FIG. 14, the control unit 7 of the server device 4 determines whether or not the selected filter characteristic allows panning in the up-down direction.

The determination as to whether or not panning is possible is made, for example, in a case where a filter based on mode matching is selected as a filter for wavefront synthesis, it is determined that panning is impossible. On the other hand, in a case where a filter based on SDM is selected as a filter for wavefront synthesis, it is determined that panning is possible.

In addition, in a case where a filter capable of performing wavefront synthesis even in a case of being used in only one of the first upper speaker array SAU1 and the first lower speaker array SAL1 is used in both the first upper speaker array SAU1 and the first lower speaker array SAL1 (including a case where only filter coefficients are different or the like), it may be determined that panning is possible.

In a case where it is determined that the filter characteristic does not allow panning, the processing in step S412 and step S413 described later is not executed and is avoided.

On the other hand, in a case where it is determined that the filter characteristic allows panning, in step S412, the control unit 7 of the server device 4 determines whether or not the deviation in the height direction between the head position of the first user U1 and the position of the virtual sound source is equal to or less than a first threshold Th1 (for example, 30 cm). Note that, in a case where there is a plurality of first users U1, the determination processing may be performed on the basis of the height of the average position of the first users U1.

In a case where it is determined that the deviation in the height direction is equal to or less than the first threshold Th1, the control unit 7 of the server device 4 selects the filter characteristic of the filter for performing panning in step S413. The filter for performing panning is applied to a case where the virtual sound source and the position of the head in the height direction are close to each other, and is for providing the user with a better sound field experience.

For example, in a case where the virtual sound source is at a higher position than the head of the first user U1, it is possible to emphasize that the virtual sound source is at a higher position by making the output sound of the first upper speaker array SAU1 stronger.

On the other hand, in a case where the virtual sound source is at a lower position than the head of the first user U1, it is possible to emphasize that the virtual sound source is at a lower position by making the output sound of the first lower speaker array SAL1 stronger.

Note that, instead of emphasizing the position of the virtual sound source by enhancing the output sound, similar effects may be obtained by weakening the output sound of the speaker array on the opposite side.

Subsequently, in step S414, the control unit 7 of the server device 4 determines whether or not the position of the virtual sound source in the up-down direction is located higher than the height of the center of the first space SP1 by a second threshold Th2 (for example, 30 cm) or more.

In a case where it is determined that the position is higher by the second threshold Th2 or more, the control unit 7 of the server device 4 sets a filter characteristic for increasing the gain on the high-frequency side in step S415. The filter having the filter characteristic is, for example, HPF, the cutoff frequency is set to 8 kHz, and the gain calculated by following Formula (1) is set.

((Position of Virtual Sound Source in Up-Down Direction)−(Height of Center of First Space SP1)−Th2)/10 Formula (1)

Note that all units of Formula (1) are [cm].

For example, in a case where the height of the virtual sound source is located 40 cm above the center of the first space SP1, the gain is set to 1 dB.

The acoustic output to which the HPF thus obtained is applied may be performed, or the acoustic output in which the acoustic signal to which the HPF is applied and the acoustic signal before the filter processing are mixed may be performed.

When the processing in step S415 is finished, the control unit 7 of the server device 4 finishes the series of processing illustrated in FIGS. 13 and 14.

On the other hand, in a case where it is determined in the processing of step S414 that the position of the virtual sound source in the up-down direction is not located higher than the height of the center of the first space SP1 by the second threshold Th2 (for example, 30 cm) or more, the control unit 7 of the server device 4 determines in step S416 whether or not the position of the virtual sound source in the up-down direction is located lower than the height of the center of the space by the second threshold Th2 or more.

In a case where it is determined that the position is lower by the second threshold Th2 or more, the control unit 7 of the server device 4 sets a filter characteristic for increasing the gain on the low-frequency side in step S417. The filter having the filter characteristic is, for example, LPF, the cutoff frequency is 200 Hz, and the gain calculated by following Formula (2) is set.

((Height of Center of First Space SP1)−(Position of Virtual Sound Source in Up-Down Direction)−Second Threshold)/10 Formula (2)

Note that all units of Formula (2) are [cm].

For example, in a case where the height of the virtual sound source is located 40 cm below the center of the first space SP1, the gain is set to 1 dB.

The acoustic output to which the LPF thus obtained is applied may be performed, or the acoustic output in which the acoustic signal to which the LPF is applied and the acoustic signal before the filter processing are mixed may be performed.

When the processing in step S417 is finished, the control unit 7 of the server device 4 finishes the series of processing illustrated in FIGS. 13 and 14.

Note that the series of processing illustrated in FIGS. 13 and 14 is performed for each virtual sound source. As a result, it is possible to provide a good sound field in which each user can be provided with a sound field in which each of a plurality of virtual sound sources is localized at a predetermined position.

When the score for each filter characteristic is calculated by the series of processing illustrated in FIG. 13, it is not necessary to add points by the processing of step S407. That is, the additional point may be only the additional point performed in step S406 in a case where the head position of the first user U1 is included in the sound reception area ARH.

As a result, the larger the number of first users U1 included in the sound reception area ARH, the higher the score. Therefore, it is possible to select filter characteristics including the largest number of first users U1 in the sound reception area ARH.

### 5. Correction of Space Size

When the first space SP1 and the second space SP2 have the same size, it is easy to determine the position of each user and the position of the virtual sound source in the first fusion space SP1′ obtained by virtually fusing the second space SP2 to the first space SP1 and the second fusion space SP2′ obtained by virtually fusing the first space SP1 to the second space SP2.

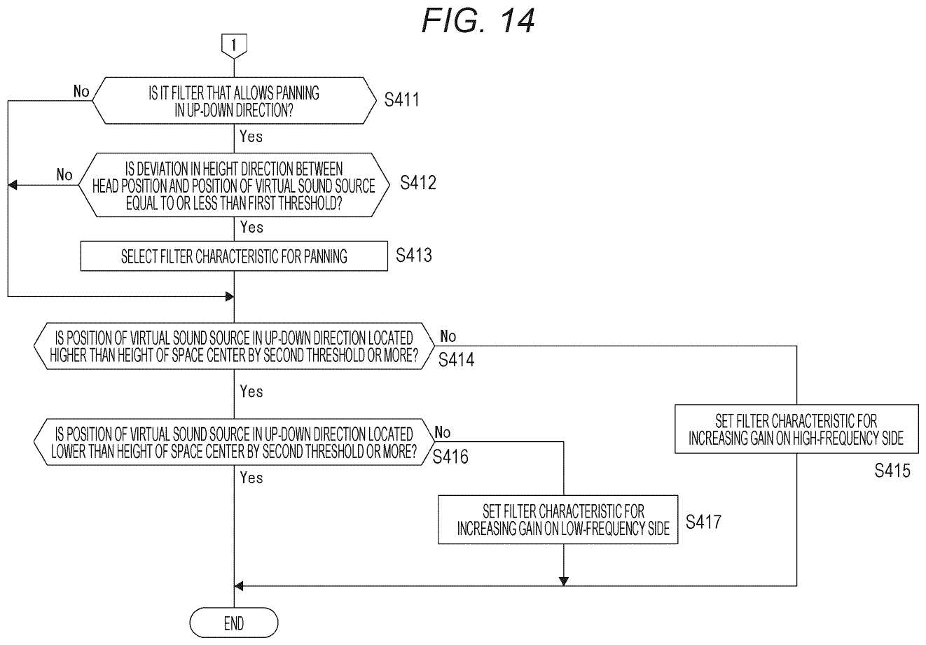

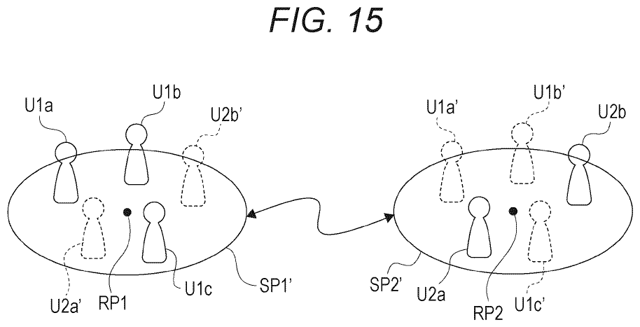

Specifically, as illustrated in FIG. 15, the coordinate position on the first fusion space SP1′ is only required to be determined on the basis of each coordinate position determined on the second space SP2.

Note that the first space SP1 and the second space SP2 may have the same size only in a case where the first space SP1 and the second space SP2 have exactly the same shape and all of the horizontal width, the depth, and the height completely match, but the first space SP1 and the second space SP2 may have the same size while allowing a certain degree of difference. For example, when the difference between the horizontal width, the depth, and the height is less than 10% or the like, the size may be determined to be the same.

The sizes of the first space SP1 and the second space SP2 may not be the same depending on the number of speaker arrays, the number of speakers SPK included in the speaker array, or the separation distance between the upper speaker array and the lower speaker array.

In such a case, it is necessary to consider how to reflect each coordinate position in the second space SP2 to the first fusion space SP1′.

A specific example will be described.

FIG. 16 illustrates an example in a case where the sizes of the first space SP1 and the second space SP2 are different, specifically, an example in a case where the second space SP2 is larger than the first space SP1.

In this case, for example, it is conceivable to adapt to a space having a narrow size.

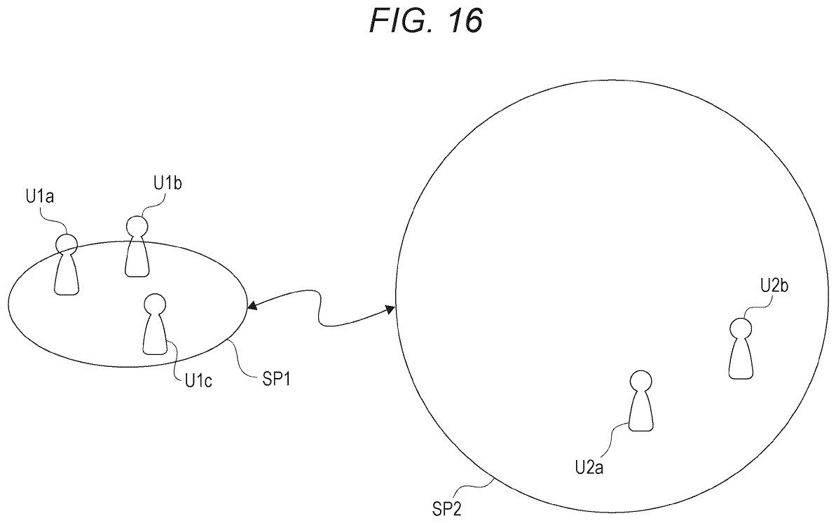

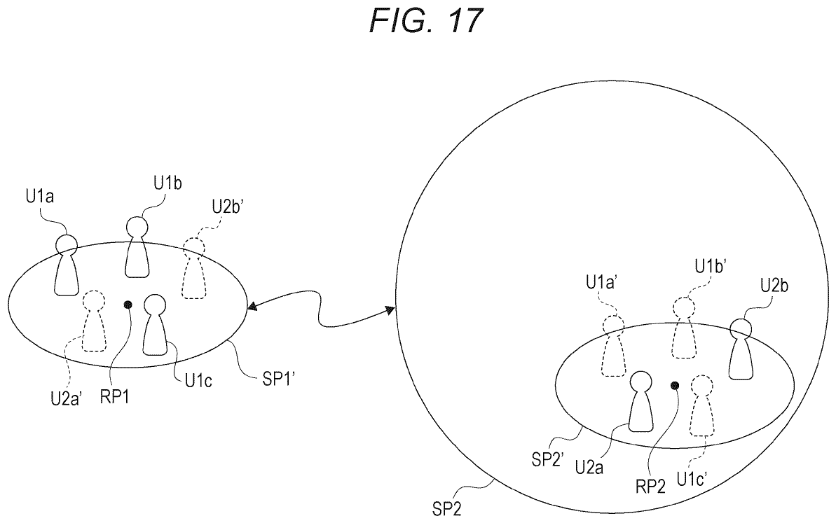

Specifically, the first fusion space SP1′ is formed by virtually fusing a partial space of the second space SP2 selected in accordance with the size of the first space SP1 to the first space SP1 (see FIG. 17).

Similarly, the second fusion space SP2′ is formed by virtually fusing the first space SP1 to a partial space of the second space SP2.

Several selection methods for selecting a partial space in the second space SP2 can be considered.

For example, the second reference position RP2 may be determined by drawing a perpendicular line from the average position of one or a plurality of second users U2 existing in the second space SP2 to the floor surface, and a partial space cut into the same shape as the first space SP1 may be selected on the basis of the second reference position RP2.

Alternatively, a partial space may be selected so that all the second users U2 existing in the second space SP2 are included in the range. Furthermore, in a case where all the users cannot be included, a partial space may be selected so that as many users as possible are included.

In addition, the second reference position RP2 may be determined such that the average value of the distances between each second user U2 and the second reference position RP2 existing in the second space SP2 becomes small, or the second reference position RP2 may be determined such that the maximum value of the distances between each second user U2 and the second reference position RP2 becomes the smallest.

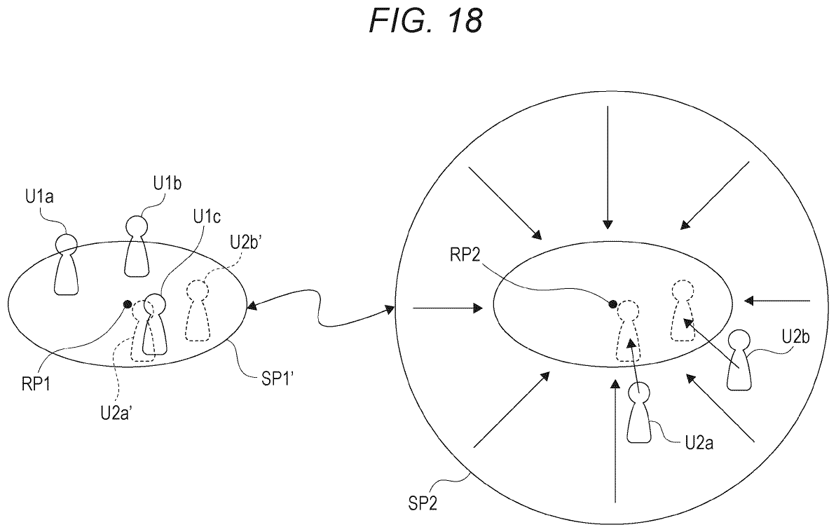

Alternatively, all the coordinates in the second space SP2 may be included in the first fusion space SP1′ by compressing the second space SP2 to an equivalent size to the first space SP1 (see FIG. 18).

Similarly, by expanding the first space SP1 to an equivalent size to the second space SP2, the first virtual sound source position LC1′ for the first user U1 can be arranged in the second fusion space SP2′ while maintaining the positional relationship of each first user U1 in the first space SP1 (see FIG. 19).

### 6. Correction Processing for Arrangement of Virtual Sound Source

The correction of the position performed when arranging the virtual sound source will be described. An example is illustrated with reference to the accompanying drawings. Note that the processing related to the position correction is executed by the position information acquisition unit 41 in the first information processing device 2 or the second information processing device 3, for example.

For example, in a case where the first user position LC1, which is the position of the first user U1 in the first space SP1, is close to the second virtual sound source position LC2′, which is the sound image position of the uttered voice of U2 of the second user arranged in the first space SP1, specifically, in the case of the example illustrated in FIG. 18, there is a possibility that an appropriate sound field cannot be provided. In such a case, the position of the virtual user is corrected.

Each of the drawings including FIG. 20 illustrates an arrangement example of the first user U1 and the virtual sound source when the first space SP1 is viewed from above.

Note that an example is illustrated in which two first users U1a and U1b are located in the first space SP1, and two second users U2a and U2b are located in the second space SP2.

The position of the first user U1a in the first space SP1 is defined as a first user position LCla, and the position of the first user U1b is defined as a first user position LC1b. As illustrated in FIG. 20, for example, the coordinates of the first user positions LC1a and LC1b are determined on the basis of the relative position with respect to the first reference position RP1 set in the first space SP1.

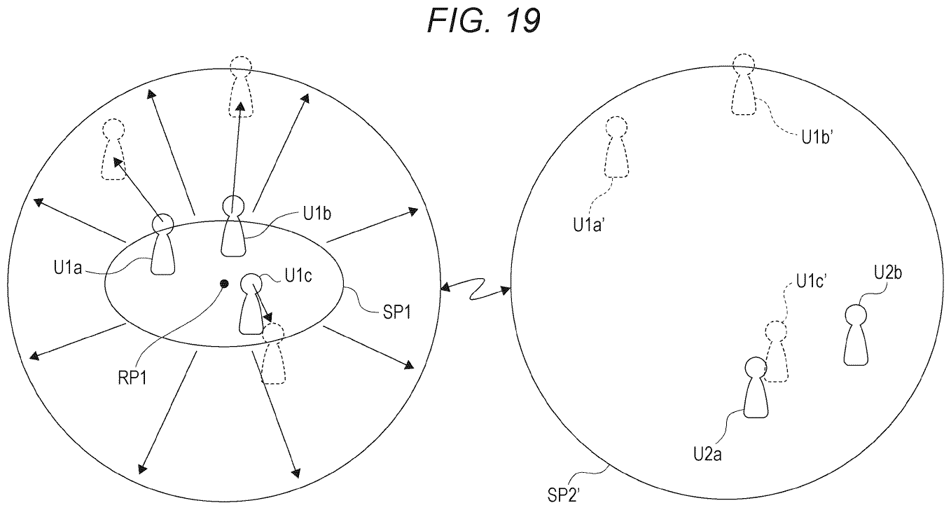

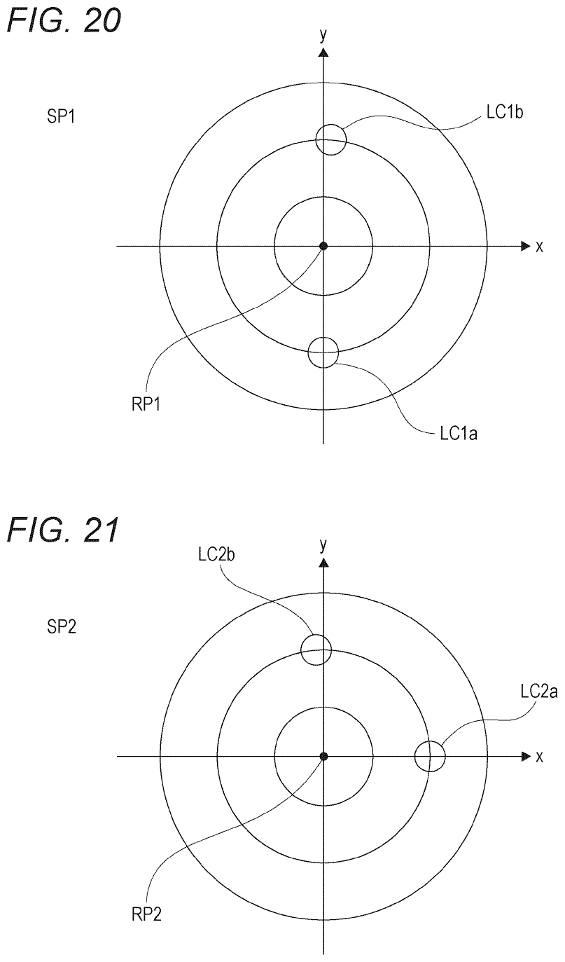

The position of the second user U2a in the second space SP2 is defined as a second user position LC2a, and the position of the second user U2b is defined as a second user position LC2b. As illustrated in FIG. 21, for example, the coordinates of the second user positions LC2a and LC2b are determined on the basis of the relative position with respect to the second reference position RP2 set in the second space SP2.

FIG. 22 illustrates a state in which the position of the second user U2 in the second space SP2 is reflected in the first fusion space SP1′ so that the first reference position RP1 and the second reference position RP2 coincide with each other.

As illustrated, the second virtual sound source position LC2a′ for the second user U2a and the second virtual sound source position LC2b′ for the second user U2b are determined.

Here, the first user position LC1b for the first user U1b and the second virtual sound source position LC2b′ for the second user U2b are very close positions. For example, in a case where the first user U1b is located at the first user position LC1b and a person as the second user U2b is virtually located at the second virtual sound source position LC2b′, the first user U1b and the second user U2b are in such a close positional relationship that parts of their bodies interfere with each other.

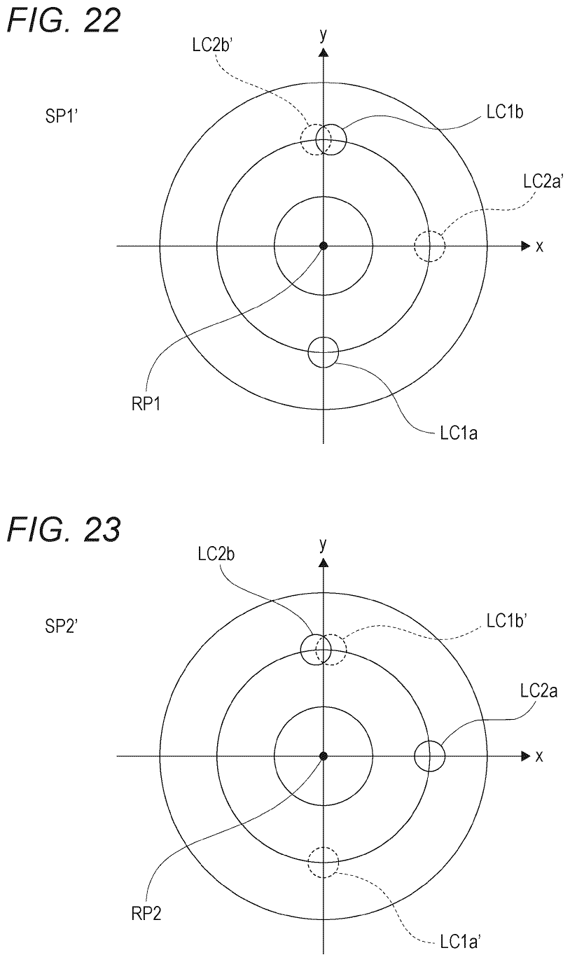

FIG. 23 illustrates a state in which the position of the first user U1 in the first space SP1 is reflected in the second fusion space SP2′ so that the first reference position RP1 and the second reference position RP2 coincide with each other. Also in the drawing, the second user position LC2b for the second user U2b and the first virtual sound source position LC1b′ for the first user U1b are very close positions.

In such a state, if the sound image of the uttered voice of the second user U2b is localized at the second virtual sound source position LC2b′, the uttered voices of the first user U1b and the second user U2b are heard from substantially the same position, and there is a possibility that an appropriate sound field cannot be provided.

In such a case, in the first space SP1, the position of the virtual sound source of at least one of the second user U2a or the second user U2b is corrected.

Furthermore, in the second space SP2, the position of the virtual sound source of at least one of the first user U1a or the first user U1b is corrected.

Some examples of position correction will be described.

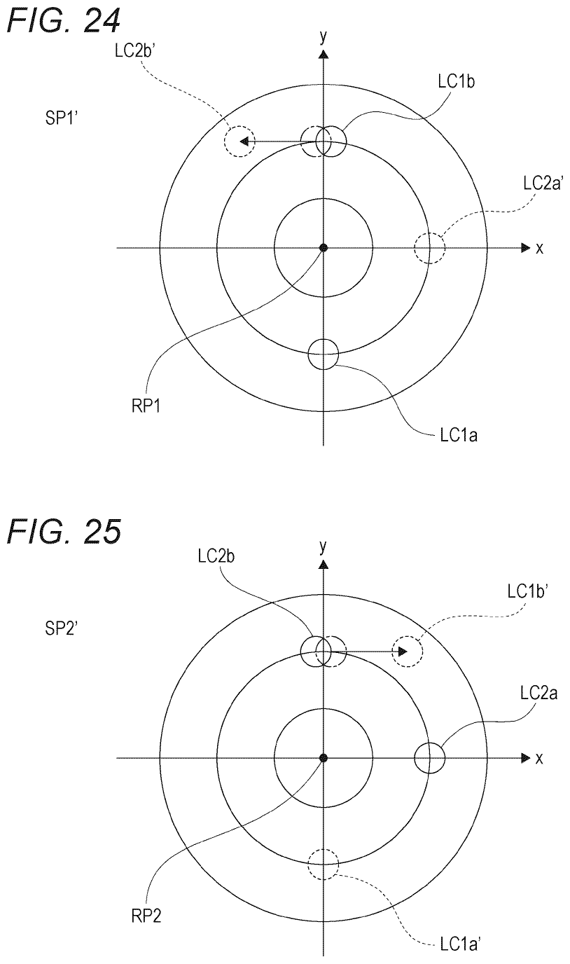

A first method illustrated in FIGS. 24 and 25 is a method of increasing the distance between the user and the sound source position while maintaining the direction of the vector between the users to be corrected.

Specifically, in the first fusion space SP1′, the y coordinates of the second virtual sound source position LC2b′ and the first user position LC1b coincide with each other (see FIG. 22). That is, the vector in which the start point is the first user position LC1b and the end point is the second virtual sound source position LC2b′ can be expressed as (−a, 0).

At this time, the second virtual sound source position LC2b′ is corrected so that the vector in which the start point is the first user position LC1b and the end point is the second virtual sound source position LC2b′ is (−na, 0) (where n>1) (see FIG. 24). Note that the position before correction is indicated by a dashed-dotted circle. It similarly applies to the following drawings.

In addition, in the second fusion space SP2′, the first virtual sound source position LC1b′ is corrected such that the vector in which the start point is the first virtual sound source position LC1b′ and the end point is the second user position LC2b becomes (−na, 0) (see FIG. 25).

As a result, the positions of the user and the virtual sound source can be appropriately separated in both the first fusion space SP1′ and the second fusion space SP2′.

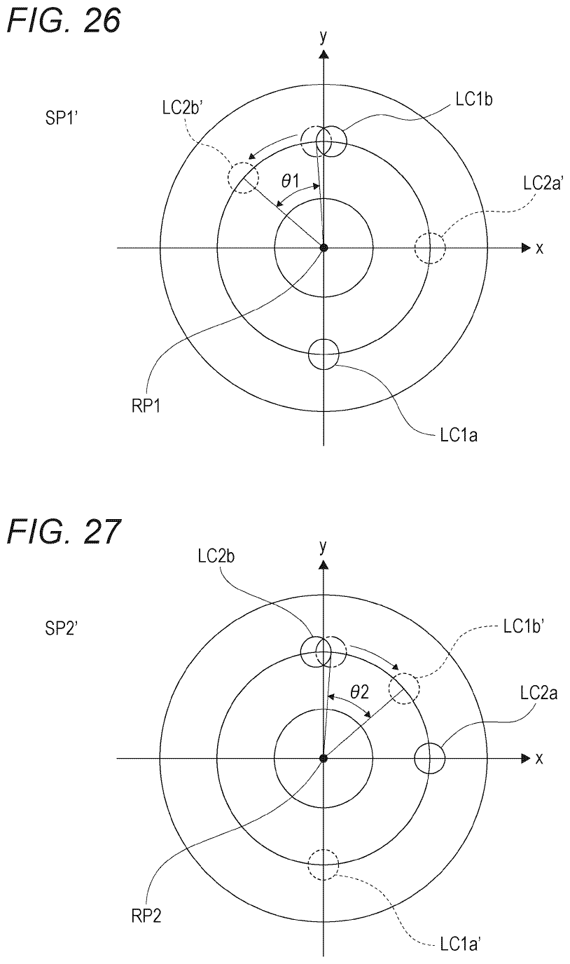

A second method for correcting the position illustrated in FIGS. 26 and 27 is a method for correcting the position of each virtual sound source so that the distance to the reference position RP does not change.

Specifically, when the polar coordinate representation is considered in the first fusion space SP1′, the deflection angle for the second virtual sound source position LC2b′ is larger than that for the first user position LC1b (see FIG. 22).

Therefore, by adding θ1 to the deflection angle of the second virtual sound source position LC2b′, the second virtual sound source position LC2b′ is set at a position away from the first user position LC1b (see FIG. 26).

In addition, in the second fusion space SP2′, the first virtual sound source position LC1b′ is set at a position away from the second user position LC2b by adding (−θ1) to the deflection angle of the first virtual sound source position LC1b′. However, in this case, the first virtual sound source position LC1b′ is too close to the second user position LC2a. Therefore, the first virtual sound source position LC1b′ may be set at a position between the second user position LC2a and the second user position LC2b by adding (−θ2) (where θ2<θ1) to the deflection angle of the first virtual sound source position LC1b′ (see FIG. 27).

A third method for position correction is a method for correcting the position of the virtual sound source in polar coordinates, but is a method used in a case where the positions of the user and the virtual sound source cannot be largely separated from each other even if the second method is used because the radius of curvature of the positions of the user to be corrected or the virtual sound source is small. Specifically, in the third method, the radius of curvature of the virtual sound source is corrected to increase the distance between the positions of the user and the virtual sound source.

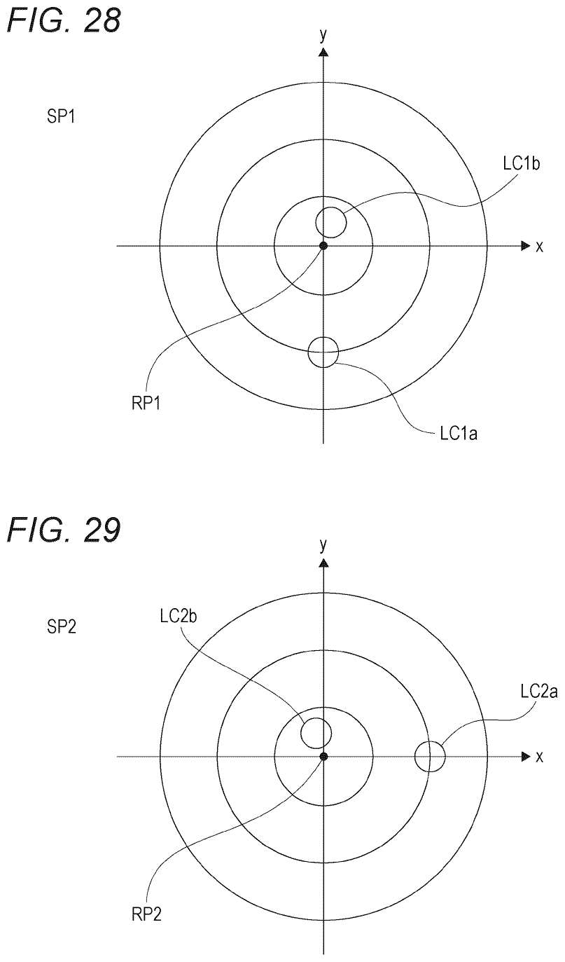

First, the positions of the first user U1a and the first user U1b in the first space SP1 are illustrated in FIG. 28. Further, the positions of the second user U2a and the second user U2b in the second space SP2 are illustrated in FIG. 29.

The first user position LC1b and the second virtual sound source position LC2b′ have small radius of curvature, and thus are positions close to the first reference position RP1 and the second reference position RP2, which are the origin of the polar coordinates.

Therefore, in the first fusion space SP1′, by increasing the radius of curvature of the second virtual sound source position LC2b′, the second virtual sound source position LC2b′ is arranged at a position away from the first user position LC1b (see FIG. 30).

In addition, in the second fusion space SP2′, the radius of curvature of the first virtual sound source position LC1b′ is changed so as to maintain the positional relationship between the first user position LC1b and the second virtual sound source position LC2b′ in the first fusion space SP1′ as much as possible.

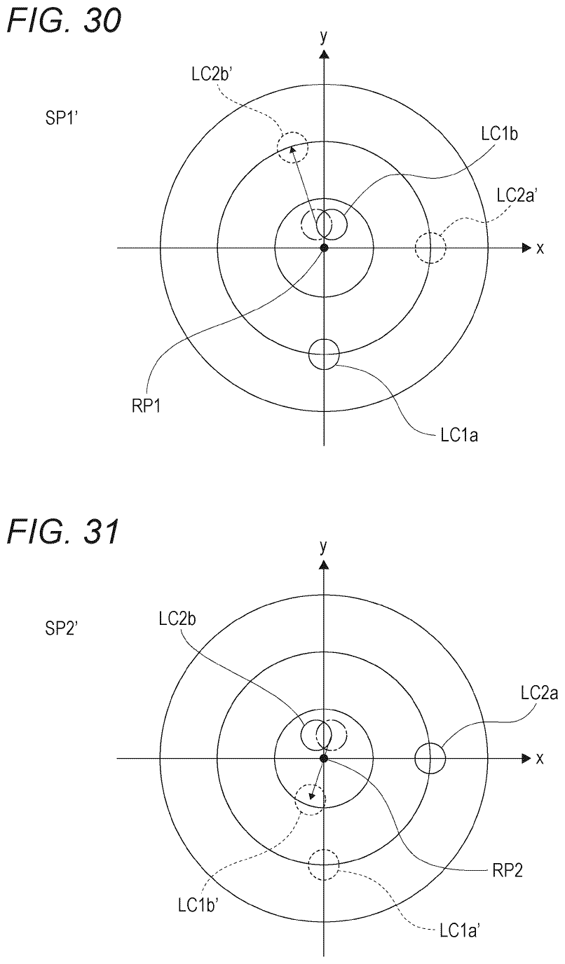

Specifically, the radius of curvature of the first virtual sound source position LC1b′ is set to a negative value and the absolute value is increased. At this time, the value of the radius of curvature is corrected so that the distance to the second user position LC2a is not too short (see FIG. 31). Note that this correction is synonymous with correcting the radius of curvature to a positive value while adding n to the deflection angle of the first virtual sound source position LC1b′.

Although it has been described that the third method is selected because the radius of curvature is small, the first reference position RP1 and the second reference position RP2 may be set again so that the radius of curvature on polar coordinates for each user position is equal to or larger than a predetermined value. As a result, the second method can be used.

Note that the example has been described in which the second virtual sound source position LC2′ is determined using the position information of the second user U2 transmitted from the second information processing device 3 in the first fusion space SP1′, and the first virtual sound source position LC1′ is determined using the position information of the first user U1 transmitted from the first information processing device 2 in the second fusion space SP2′.

As a method other than this, the user may arbitrarily determine the virtual sound source position without using the position information received from another information processing device.

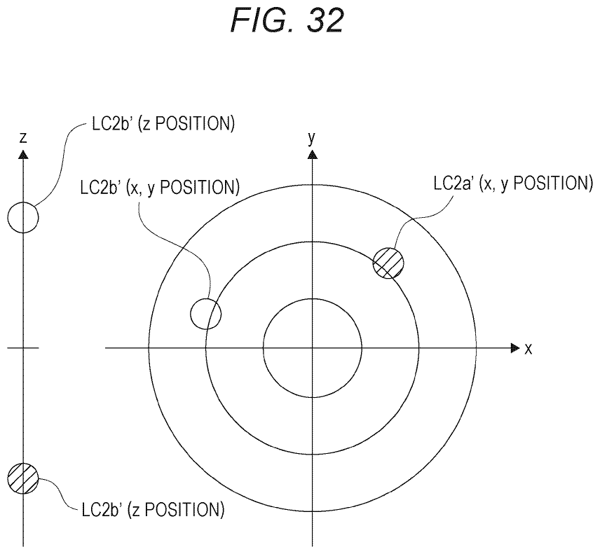

For example, by using an application as illustrated in FIG. 32, the user can arbitrarily determine the position of the virtual sound source in the horizontal plane and the up-down direction.

### 7. Second Embodiment

In the above-described example, an example has been described in which the first lower speaker array SAL1 and the second lower speaker array SAL2 are arranged on the floor surface or under the floor.

The second embodiment is an example in which a part of a speaker array is attached to a table. That is, in the present embodiment, a part of the speaker array is located above the floor surface and below the head of the person in the standing state.

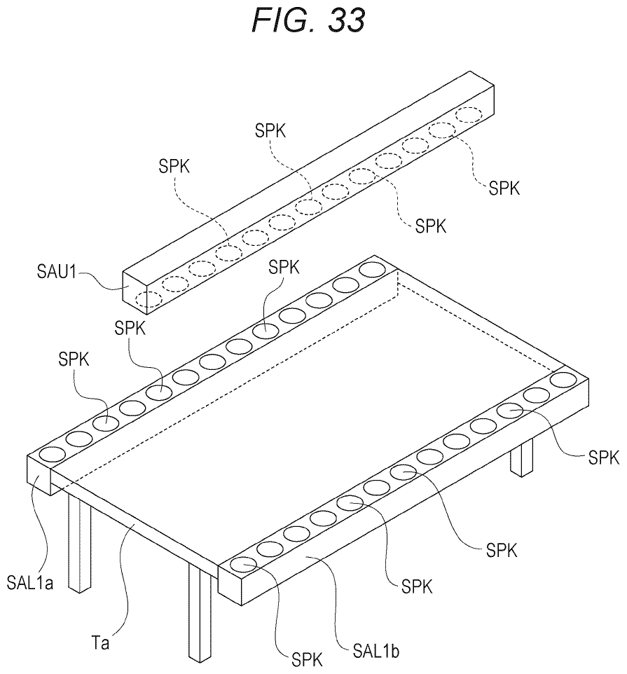

Specifically, as illustrated in FIG. 33, three speaker arrays are arranged in the first space SP1 in which the table Ta is installed. The first upper speaker array SAU1 is disposed above the center of the table Ta such that the speakers SPK are arranged in the longitudinal direction of the table Ta.

In the remaining two, the first lower speaker array SAL1a is attached to one end portion in the lateral direction of the table Ta, and the first lower speaker array SAL1b is attached to the other end portion in the lateral direction.

A signal to which a filter characteristic for wavefront synthesis is applied is given to each speaker SPK included in the first upper speaker array SAU1 and the first lower speaker arrays SAL1a and SAL1b, thereby forming the sound reception area ARH and the virtual sound source arrangeable area ARP in the vicinity of the table Ta.

Some examples will be described with reference to the accompanying drawings.

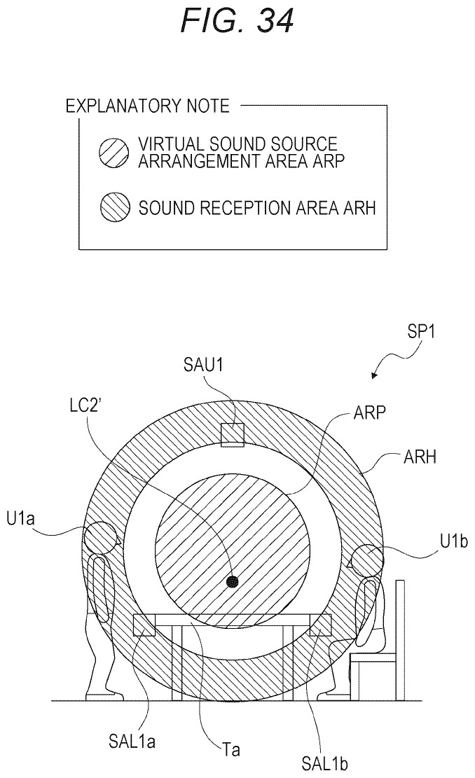

In FIG. 34, a first user U1a in a standing state and a first user U1b in a state of sitting on a chair are located around the table Ta.

At this time, as the filter characteristics for wavefront synthesis, filter characteristics are selected in which the virtual sound source arrangeable area ARP is formed in a cylindrical shape with the longitudinal direction of the table Ta as the axial direction, and the sound reception area ARH is formed in a tubular shape slightly larger than the cylindrical shape.

Accordingly, the head positions of the first user U1a standing along the longitudinal side of the table Ta and the first user U1b sitting are included in the sound reception area ARH. Therefore, for example, a sound field in which a sound image is formed at the second virtual sound source position LC2′ on the table Ta can be provided to each first user U1.

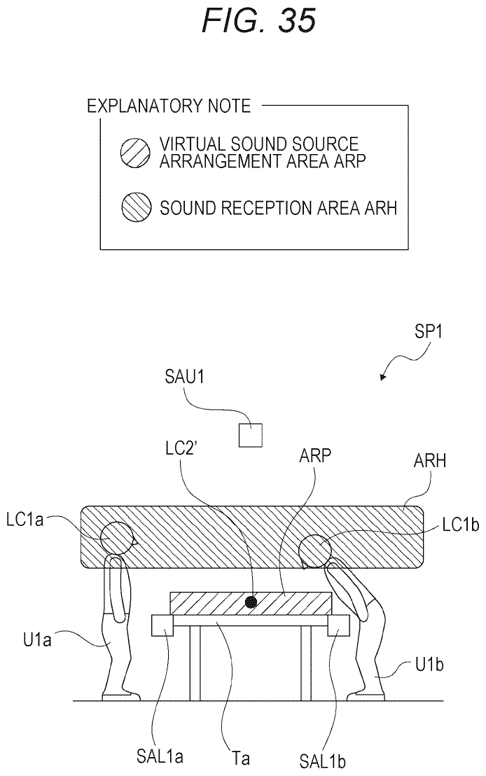

FIG. 35 illustrates an example in which the first users U1a and U1b in the standing state are located around the table Ta. In addition, since the first user U1b takes a posture in which the head is raised on the table Ta, there is a possibility that an appropriate sound field cannot be provided to the first user U1b in a case where the filter characteristic illustrated in FIG. 34 is applied.

In the example illustrated in FIG. 35, filter characteristics for forming the sound reception area ARH are selected so as to spread horizontally with a certain vertical width.

As a result, even in a case where the first user U1b takes a posture of leaning forward with respect to the table Ta, an appropriate sound field can be provided.

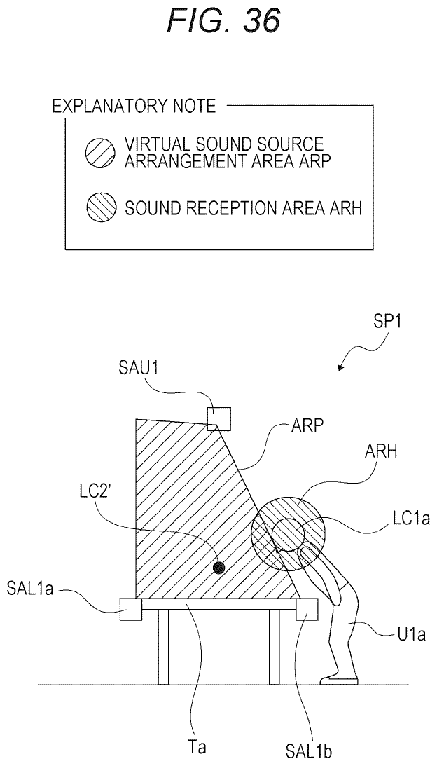

FIG. 36 illustrates an example in a case where one first user U1a is located near the table Ta. In this case, since the head position of the first user U1a can be specified as the first user position LC1a, an optimum sound field can be provided to the first user U1a by narrowing the sound reception area ARH.

That is, the filter characteristics are selected such that the sound reception area ARH is set to the vicinity of the first user position LC1a and the virtual sound source arrangeable area ARP is set to a wide region in front of the first user position LC1a.

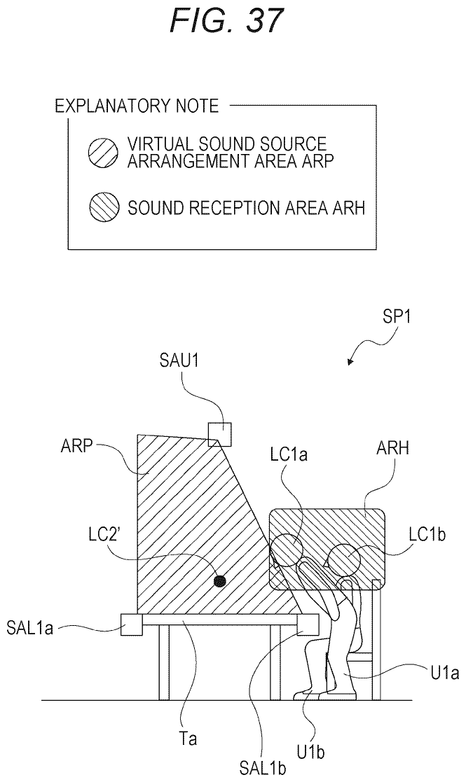

FIG. 37 illustrates an example in a case where two first users U1a and U1b are located side by side along one side of the table Ta.

In this case, since there is a plurality of first users U1a, the sound reception area ARH cannot be made narrower than in the example illustrated in FIG. 36, but the sound reception area ARH can be made narrower than in the example illustrated in FIG. 34 or 35. As a result, a relatively good sound field can be provided to the first users U1a and U1b.

For example, filter characteristics are selected such that the sound reception area ARH is a relatively narrow region including the heads of the first users U1a and U2b, and the virtual sound source arrangeable area ARP is a wide region in front of the first user positions LC1a and LC1b.

### 8. Specific Examples

Specific examples of the arrangement of the speaker array and the sensing device 6 described above will be described.

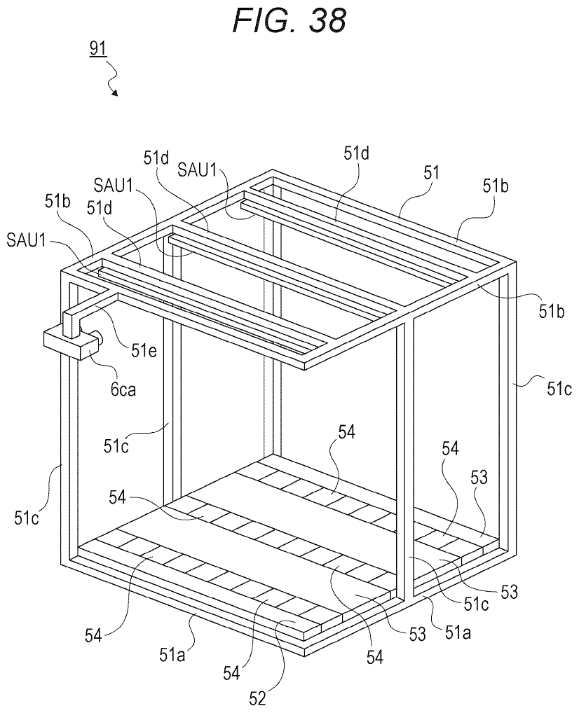

FIG. 38 illustrates a unit device 91 arranged in the first space SP1 in the audio reproduction system 1 as a first specific example.

The unit device 91 is a device installed to form the first space SP1, and may have, for example, a configuration including the above-described first information processing device 2 (not illustrated).

The unit device 91 has a unit structure including a frame portion 51, a floor surface unit 52 attached below the frame portion 51, and a plurality of first upper speaker arrays SAU1 attached above the frame portion 51. The unit device 91 can be installed at various places indoors and outdoors, and forms the first space SP1 described above at the place where it is installed. Note that, in order to facilitate movement after installation, Casters may be attached to the lower part.

The frame portion 51 includes a lower frame 51a that forms four sides below the first space SP1, an upper frame 51b that forms four sides above the first space SP1, a connection frame 51c that connects the lower frame 51a and the upper frame 51b, an arrangement frame 51d on which the first upper speaker array SAU1 is arranged, and a support frame 51e that supports a stereo camera 6ca as the sensing device 6.

An appropriate number of connection frames 51c are provided to secure the strength of the frame portion 51.

The arrangement frames 51d are provided, for example, as many as the first upper speaker arrays SAU1 provided in the first space SP1.

The first upper speaker array SAU1 includes a plurality of speakers SPK, and is attached to the lower portion of the arrangement frame 51d in a direction in which the sound output directions of the plurality of speakers SPK are downward.

The support frame 51e is a frame to which the stereo camera 6ca capable of imaging the entire first space SP1 is attached, and is arranged to extend outward from the upper frame 51b, for example.

The stereo camera 6ca capable of measuring a position of a target object (for example, a user) located in the first space SP1 is attached to the support frame 51e. The stereo camera 6ca can measure a distance to a subject, thereby acquiring a positional relationship of the subject.

The floor surface unit 52 includes the first lower speaker array SAL1 disposed immediately below the first upper speaker array SAU1 and a floor portion 53 provided between the first lower speaker arrays SAL1, and is configured in a plate shape.

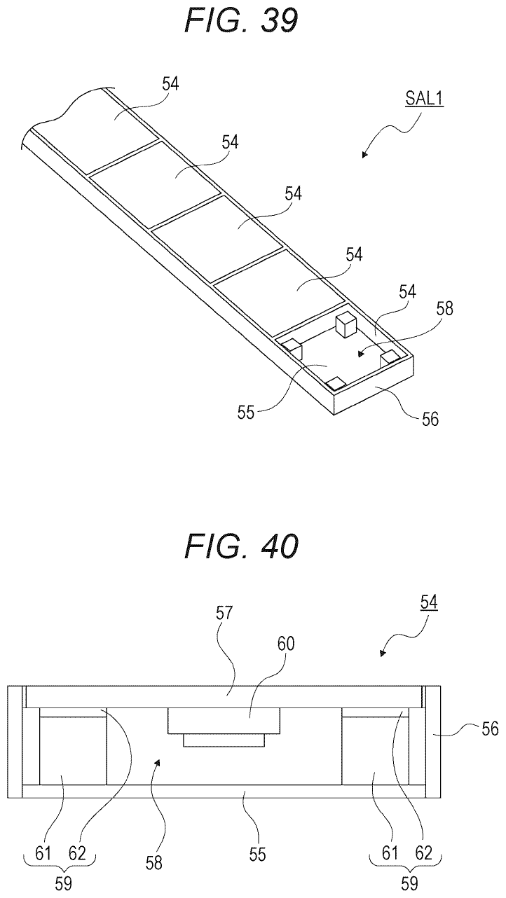

The first lower speaker array SAL1 has a configuration in which a plurality of speaker units 54 is continuously arranged in the longitudinal direction (see FIG. 39).

The speaker unit 54 includes a bottom surface portion 55, an enclosure portion 56 extending upward from four sides of the bottom surface, and a top plate portion 57 that closes a space formed by the bottom surface portion 55 and the enclosure portion 56 (see FIGS. 39 and 40).

The speaker unit 54 includes four pillar units 59 arranged at substantially four corners of an internal space 58 formed by the bottom surface portion 55, the enclosure portion 56, and the top plate portion 57, and an exciter 60 attached to a lower surface of the top plate portion 57.

The exciter 60 is an aspect of the speaker SPK and is a vibration exciter.

The top plate portion 57 is placed on the four pillar units 59. The pillar unit 59 includes a column portion 61 and a gel-like portion 62 attached to an upper portion of the column portion 61.

Since the top plate portion 57 is installed with four corners supported by the gel-like portion 62, the top plate portion 57 is easily vibrated by vibration of the exciter 60.

In addition, the top plate portion 57 is slightly smaller than the upper opening of the internal space 58 formed by the bottom surface portion 55 and the enclosure portion 56 so as to be easily vibrated by the excitation of the exciter 60. Note that the gap formed between the top plate portion 57 and the enclosure portion 56 may be filled with a deformable member such as urethane foam or an elastically deformable member such that a collision sound between the top plate portion 57 and the enclosure portion 56 is less likely to occur when the top plate portion 57 vibrates. Note that, by using the urethane foam, it is possible to prevent sound on the speaker back surface side from reaching the speaker front surface side, and to output good audio.

Note that one room may be formed as the first space SP1 by substituting the connection frame 51c with a wall and substituting the upper frame 51b with a ceiling. Furthermore, in that case, in order to reduce or eliminate the blind spot caused by the stereo camera 6ca, a plurality of stereo cameras 6ca may be installed, or a microphone array or the like may be used to acquire position information regarding the blind spot caused by the stereo camera 6ca.

By installing the unit device 91, a space between the first upper speaker array SAU1 and the first lower speaker array SAL1 is formed as the first space SP1, and the sound reception area ARH and the virtual sound source arrangeable area ARP are appropriately formed in the first space.

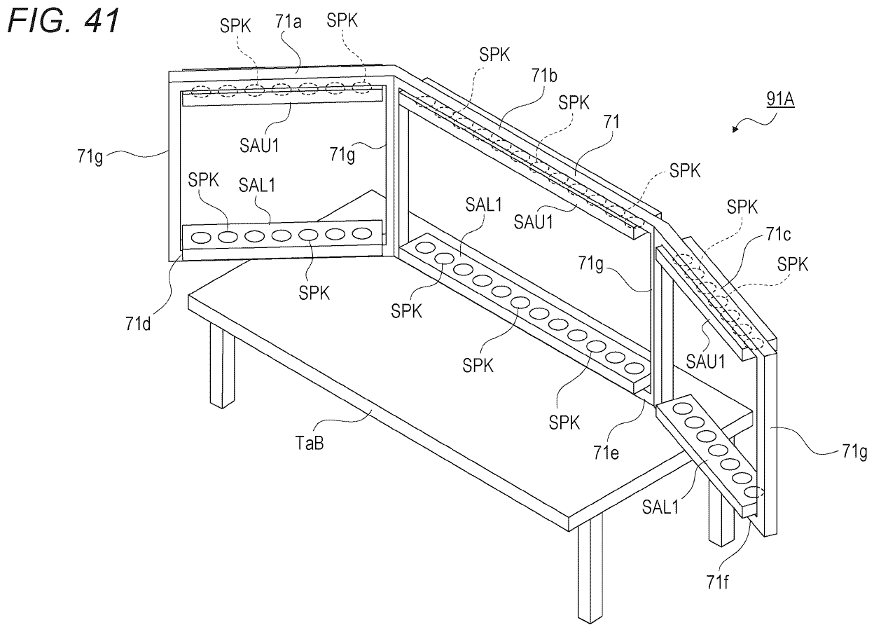

FIG. 41 illustrates a unit device 91A installed to form a first space of the audio reproduction system 1 as a second specific example.

The unit device 91A includes a table TaB, a frame portion 71 having a shape like a three-sided mirror having only a frame skeleton placed on the table TaB, and a plurality of speaker arrays attached to the frame portion 71.

The table TaB is a simple table not including the speaker array as illustrated in FIG. 33.

The frame portion 71 includes a left upper frame 71a extending in the horizontal direction, a middle upper frame 71b extending in the horizontal direction from one end of the left upper frame 71a, a right upper frame 71c extending in the horizontal direction from one end of the middle upper frame 71b, a left lower frame 71d located below the left upper frame 71a, a middle lower frame 71e extending in the horizontal direction from one end of the left lower frame 71d and located below the middle upper frame 71b, and a right lower frame 71f extending in the horizontal direction from one end of the middle lower frame 71e and located below the right upper frame 71c.

The first upper speaker array SAU1 is attached to a lower portion of each of the left upper frame 71a, the middle upper frame 71b, and the right upper frame 71c. The first upper speaker array SAU1 includes a plurality of speakers SPK, and each speaker SPK is oriented to output sound downward.

Note that the first upper speaker array SAU1 may be oriented such that sound can be output obliquely downward in order to suitably output audio to the user.

The first lower speaker array SAL1 is attached to an upper portion of each of the left lower frame 71d, the middle lower frame 71e, and the right lower frame 71f. The first lower speaker array SAL1 includes a plurality of speakers SPK, and each speaker SPK is oriented so as to be capable of outputting sound upward.

Note that the first lower speaker array SAL1 may be oriented such that sound can be output obliquely upward in order to suitably output audio to the user.

Note that the unit device 91A includes the sensing device 6 (camera or the like) for specifying the position of the first user U1 or the like as the first target object located in the first space SP1, but is not illustrated. Similarly, the sensing device 6 is not illustrated in the third specific example and the fourth specific example described later.

By installing the unit device 91A, a space between the first upper speaker array SAU1 and the first lower speaker array SAL1 is formed as the first space SP1, and the sound reception area ARH and the virtual sound source arrangeable area ARP are appropriately formed in the first space.

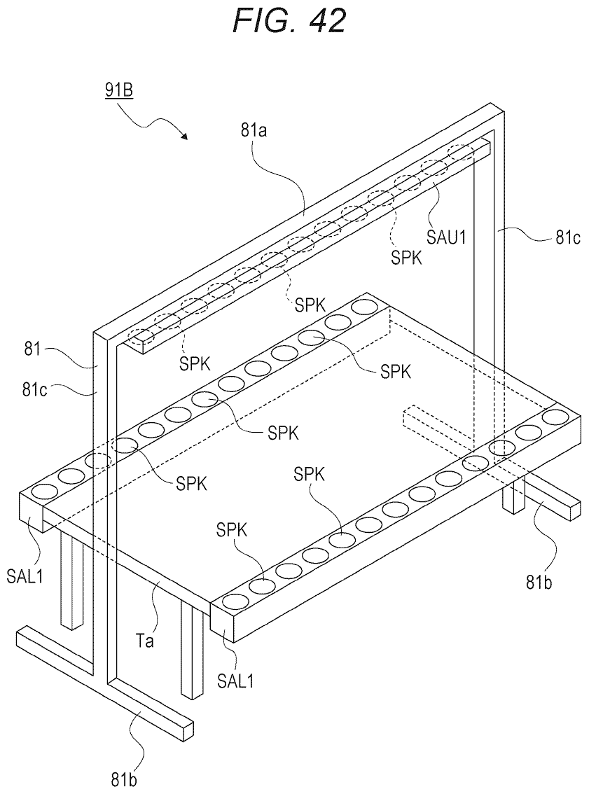

FIG. 42 illustrates a unit device 91B as a third specific example.

The unit device 91B includes a table Ta and a frame portion 81.

The table Ta has a configuration similar to the table Ta illustrated in FIG. 33, and the first lower speaker array SAL1 is attached to each of both end portions in the lateral direction.

The frame portion 81 is formed in a frame shape including an upper frame 81a extending in the direction in which the respective speakers SPK of the first lower speaker array SAL1 are arranged, two leg frames 81b, and two connection frames 81c connecting the upper frame 81a and the leg frames 81b.

The first upper speaker array SAU1 is attached to a lower portion of the upper frame 81a.

By installing the unit device 91B, a space between the first upper speaker array SAU1 and the first lower speaker array SAL1 is formed as the first space SP1, and the sound reception area ARH and the virtual sound source arrangeable area ARP are appropriately formed in the first space.

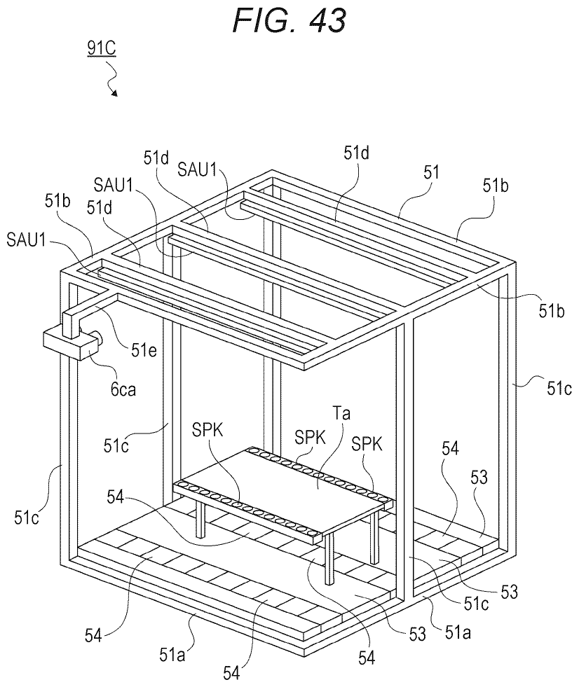

FIG. 43 illustrates a unit device 91C as a fourth specific example.

The unit device 91C is a combination of the unit device 91 illustrated in FIG. 38 and the table Ta including the first lower speaker arrays SAL1a and SAL1b illustrated in FIG. 33. However, since the first lower speaker array SAL is attached to the end portion of the table Ta, the plurality of speaker units 54 functioning as the first lower speaker array SAL may not be disposed on the floor surface unit 52.

By installing the unit device 91C, a space between the first upper speaker array SAU1 and the first lower speaker array SAL1 of the table Ta or a space between the first upper speaker array SAU1 and the first lower speaker array SAL1 of the floor surface unit 52 is formed as the first space SP1, and the sound reception area ARH and the virtual sound source arrangeable area ARP are appropriately formed in the first space.

### 9. Modifications

Since the first information processing device 2, the second information processing device 3, or both of them have the function of the server device 4, the audio reproduction system 1 may not include the server device 4.

The second user position LC2 may be a predetermined position other than the head of the second user U2 on the basis of the audio reproduced in the first fusion space SP1′. For example, the second user position LC2 in a case where the second user U2 reproduces the audio by clapping the hands is based on the position of the hands of the second user U2.

Although the communication between the users has been described as an example, the first target object located in the first space SP1 may be a user, and the second target object located in the second space SP2 may be a non-person such as a musical instrument.

In addition, in the case of vibrating the top plate portion 57 of the speaker unit 54 installed on the floor as illustrated in FIG. 38, the intensity of vibration may be changed according to the weight of a heavy object (such as the first user U1) located above the top plate portion 57, that is, according to the force applied from above to the top plate portion 57.

### 10. Conclusion

As described in each of the examples described above, the first information processing device 2 as an information processing device includes: the position information acquisition unit 41 that acquires the position information of the first target object (first user U1) in the first space SP1 in which the speaker array (first speaker array SA1) is arranged and the position information of the second target object (second user U2) in the second space SP2; the position determination processing unit 42 that determines the virtual position (for example, the second virtual sound source position LC2′) of the second target object in the first fusion space SP1′ obtained by virtually fusing the second space SP2 to the first space SP1; and the output control unit 43 that performs output control of the speaker array by applying the wavefront synthesis filter to the signal obtained by collecting the sound emitted from the second target object so that the sound image is localized at the virtual position.

As a result, the virtual position of the second target object can be determined at an appropriate position in the first fusion space SP1′ according to the position of the second target object in the second space SP2.

For example, in a case where there is a plurality of second target objects in the second space SP2, the positional relationship between the second target objects can be reflected in the first fusion space SP1′ while being maintained.

Therefore, it is possible to provide an appropriate sound field without discomfort.

As described with reference to FIG. 1 and the like, the first upper speaker array SAU1 and the first lower speaker array SAL1 may be arranged in the first space SP1 as the speaker array (first speaker array SA1).

By using the first upper speaker array SAU1 and the first lower speaker array SAL1, even if a plurality of first users U1 exists at the same height position, the occurrence of occlusion with respect to the audio can be suppressed. Therefore, it is possible to prevent the localization of the sound image from being shifted and perceived.

As described with reference to FIG. 7 and the like, the output control unit 43 may select the characteristics of the wavefront synthesis filter according to the positional relationship among the first target object (first user U1), the first upper speaker array SAU1, and the first lower speaker array SAL1.

For example, the characteristic of the wavefront synthesis filter is selected such that the sound image is localized at a position between the first upper speaker array SAU1 and the first lower speaker array SAL1.

As a result, the user can perceive a sound image localized at an appropriate position.

As described with reference to FIG. 7 and the like, the output control unit 43 may select the characteristics of the wavefront synthesis filter such that the position of the first target object (first user U1) is included in the sound image localization service area (sound reception area ARH).

The wavefront synthesis processing is performed such that the first target object, specifically, the head of the first user is located in the sound reception area ARH, whereby the first user U1 can perceive the sound image localized as intended.

As described with reference to FIG. 14 and the like, the output control unit 43 may select the characteristic of the wavefront synthesis filter according to the distance between the position of the first target object (first user U1) and the virtual position (for example, the second virtual sound source position LC2′).

The distance between the position of the first target object and the virtual position is, for example, a distance in the up-down direction that is the separation direction of the first speaker array SA1 (the first upper speaker array SAU1 and the first lower speaker array SAL1). By performing the panning processing on the first upper speaker array SAU1 and the first lower speaker array SAL1 according to the distance in the up-down direction, the position of the sound image can be emphasized, and a good sound field can be provided.

As described with reference to FIG. 9 and the like, the output control unit 43 may select the characteristic of the wavefront synthesis filter according to the virtual position (for example, the second virtual sound source position LC2′).

As a result, an appropriate filter characteristic is selected according to various situations such as a case where the virtual position is set to a high position (for example, FIG. 10) and a case where the virtual position is set to a low position (for example, FIG. 11), and thus a good sound field can be provided.

As described with reference to FIG. 14 and the like, the output control unit 43 may select the characteristic of the wavefront synthesis filter according to the relationship between the position of the first upper speaker array SAU1, the position of the first lower speaker array SAL1, and the virtual position (for example, the second virtual sound source position LC2′).

This makes it possible to select appropriate filter characteristics for performing panning in the left-right direction and the up-down direction.

As described with reference to FIG. 14 and the like, the output control unit 43 may select the characteristic of the band emphasis filter according to the position in the up-down direction of the virtual position (for example, the second virtual sound source position LC2′) with respect to the first upper speaker array SAU1 and the first lower speaker array SAL1.

As a result, it is possible to select a filter characteristic for emphasizing the high-frequency side in a case where the virtual position is set to a high position, and it is possible to select a filter characteristic for emphasizing the low-frequency side in a case where the virtual position is set to a low position. Therefore, it is possible to provide a good sound field.

As described with reference to FIG. 8 and the like, in a case where there is a plurality of first target objects (first users U1), the output control unit 43 may select the characteristics of the wavefront synthesis filter according to the position information of each of the plurality of first target objects.

More specifically, the wavefront synthesis filter can be selected such that the head positions of the first users U1 as the plurality of first target objects are included in the sound reception area ARH. As a result, wavefront synthesis for each first user U1 to experience an appropriate sound field can be performed.

As described with reference to FIG. 10, the output control unit 43 may select the characteristics of the wavefront synthesis filter so that the average position of the plurality of first target objects (first users U1) is included in the sound image localization service area (sound reception area ARH) .

As a result, in a case where there is a plurality of first users U1 as the first target object, it is easy to select a wavefront synthesis filter in which the head positions of many first users U1 are included in the sound reception area ARH. Therefore, the possibility of providing an appropriate sound field to each first user U1 can be increased.

As described with reference to FIG. 13 and the like, the output control unit 43 may select the characteristics of the wavefront synthesis filter so that the number of first target objects (first user U1, more specifically, head of first user U1) included in the sound image localization service area ARH increases.

As a result, it is possible to provide an appropriate sound field to the first user U1 as a larger number of first target objects.

As described with reference to FIGS. 13, 14, and the like, in a case where there is a plurality of second target objects (for example, the second user U2), the position determination processing unit 42 may determine the virtual position (for example, the second virtual sound source position LC2′) for each of the second target objects, and the output control unit 43 may select the characteristic of the wavefront synthesis filter for each of the plurality of virtual positions.

As a result, sound images of different second target objects can be localized at different positions, and a high-quality sound field can be provided.

The first target object may be the head of the person (first user U1).

By acquiring the position of the head of the person as the first user position LC1, it is possible to provide an appropriate sound field to the ear that is a part of the head.

As described with reference to FIG. 24 and the like, the position determination processing unit 42 may perform the correction processing for the virtual position in a case where the distance between the first target object (the first user U1) and the virtual position (for example, the second virtual sound source position LC2′) in the first fusion space SP1′ is less than a predetermined value.

For example, since the first user position LC1 and the virtual sound source position can be separated to some extent by the correction processing, the possibility of providing an appropriate sound field can be increased.

As described with reference to FIG. 38 and the like, the position information acquisition unit 41 may obtain the position information of the first target object (first user U1) on the basis of the output from the stereo camera 6ca.

In a case where a microphone is used, it may be difficult to accurately specify the position or the like of the speaker due to factors such as reverberation of sound. However, since the position of the first user U1, the position of the second user U2, or the like as a speaker can be specified with high accuracy on the basis of the image captured by the stereo camera, a suitable sound field can be provided to the user.

As described in the correction of the space size with reference to FIG. 15 and the like, the position determination processing unit 42 may determine the virtual position (for example, the second virtual sound source position LC2′) on the basis of the difference in the size of the second space SP2 and the size of the first space SP1.

As a result, even if the space sizes are different from each other, the virtual sound source position can be appropriately arranged, and a sound field without discomfort can be provided.

### 11. Present Technology

Note that the present technology can have the following configurations.
(1)

An information processing device including:
a position information acquisition unit that acquires position information of a first target object in a first space in which a speaker array is arranged and position information of a second target object in a second space;
a position determination processing unit that determines a virtual position of the second target object in a first fusion space obtained by virtually fusing the second space to the first space; and
an output control unit that performs output control of the speaker array by applying a wavefront synthesis filter to a signal obtained by collecting a sound emitted from the second target object such that a sound image is localized at the virtual position.
(2)

The information processing device according to (1),
in which a first upper speaker array and a first lower speaker array are arranged as the speaker array in the first space.
(3)

The information processing device according to (2),
in which the output control unit selects a characteristic of the wavefront synthesis filter according to a positional relationship among the first target object, the first upper speaker array, and the first lower speaker array.
(4)

The information processing device according to (3),
in which the output control unit selects a characteristic of the wavefront synthesis filter such that a position of the first target object is included in a sound image localization service area.
(5)

The information processing device according to any one of (2) to (4),
in which the output control unit selects a characteristic of the wavefront synthesis filter according to a distance between a position of the first target object and the virtual position.
(6)

The information processing device according to any one of (2) to (5),
in which the output control unit selects a characteristic of the wavefront synthesis filter according to the virtual position.
(7)

The information processing device according to (6),
in which the output control unit selects a characteristic of the wavefront synthesis filter according to a relationship among a position of the first upper speaker array, a position of the first lower speaker array, and the virtual position.
(8)

The information processing device according to (7),
in which the output control unit selects a characteristic of a band emphasis filter according to a position in an up-down direction of the virtual position with respect to the first upper speaker array and the first lower speaker array.
(9)

The information processing device according to any one of (2) to (8),
in which the output control unit selects a characteristic of the wavefront synthesis filter according to position information of each of a plurality of the first target objects in a case where there is the plurality of the first target objects.
(10)

The information processing device according to (9),
in which the output control unit selects a characteristic of the wavefront synthesis filter such that an average position of a plurality of the first target objects is included in a sound image localization service area.
(11)

The information processing device according to (9),
in which the output control unit selects a characteristic of the wavefront synthesis filter such that the number of the first target objects included in a sound image localization service area increases.
(12)

The information processing device according to any one of (1) to (11),
in which in a case where there is a plurality of the second target objects,
the position determination processing unit determines the virtual position for each of the plurality of the second target objects, and
the output control unit selects a characteristic of the wavefront synthesis filter for each of a plurality of the virtual positions.
(13)

The information processing device according to any one of (1) to (12),
in which the first target object is a head of a person.
(14)

The information processing device according to any one of (1) to (13),
in which the position determination processing unit performs correction processing for the virtual position in a case where a distance between the first target object and the virtual position in the first fusion space is less than a predetermined value.
(15)

The information processing device according to any one of (1) to (14),
in which the position information acquisition unit obtains position information of the first target object on the basis of an output from a stereo camera.
(16)

The information processing device according to any one of (1) to (15),
in which the position determination processing unit determines the virtual position on the basis of a difference in a size of the second space and a size of the first space.
(17)

An information processing method in which an arithmetic processing device performs:
a process of acquiring position information of a first target object in a first space in which a speaker array is arranged and position information of a second target object in a second space;
a process of determining a virtual position of the second target object in a first fusion space obtained by virtually fusing the second space to the first space; and
a process of performing output control of the speaker array by applying a wavefront synthesis filter to a signal obtained by collecting a sound emitted from the second target object such that a sound image is localized at the virtual position.
(18)

A storage medium storing a program for causing an arithmetic processing device to perform:
a process of acquiring position information of a first target object in a first space in which a speaker array is arranged and position information of a second target object in a second space;
a process of determining a virtual position of the second target object in a first fusion space obtained by virtually fusing the second space to the first space; and
a process of performing output control of the speaker array by applying a wavefront synthesis filter to a signal obtained by collecting a sound emitted from the second target object such that a sound image is localized at the virtual position.

### REFERENCE SIGNS LIST

1 Audio reproduction system
2 First information processing device
6ca Stereo camera
41 Position information acquisition unit
42 Position determination processing unit
43 Output control unit
SP1 First space
SP2 Second space
SP1′ First fusion space
SA1 First speaker array (speaker array)
SAU1 First Upper Speaker Array
SAL1, SAL1a, SAL1b First lower speaker array
LC2′, LC2a′, LC2b′ Second virtual sound source position (virtual position)
U1, U1a, U1b, U1c First user (first target object)
U2, U2a, U2b Second user (second target object)
ARH Sound reception area

1. An information processing device comprising:
a position information acquisition unit that acquires position information of a first target object in a first space in which a speaker array is arranged and position information of a second target object in a second space;
a position determination processing unit that determines a virtual position of the second target object in a first fusion space obtained by virtually fusing the second space to the first space; and
an output control unit that performs output control of the speaker array by applying a wavefront synthesis filter to a signal obtained by collecting a sound emitted from the second target object such that a sound image is localized at the virtual position.

2. The information processing device according to claim 1,
wherein a first upper speaker array and a first lower speaker array are arranged as the speaker array in the first space.

3. The information processing device according to claim 2,
wherein the output control unit selects a characteristic of the wavefront synthesis filter according to a positional relationship among the first target object, the first upper speaker array, and the first lower speaker array.

4. The information processing device according to claim 3,
wherein the output control unit selects a characteristic of the wavefront synthesis filter such that a position of the first target object is included in a sound image localization service area.

5. The information processing device according to claim 2,
wherein the output control unit selects a characteristic of the wavefront synthesis filter according to a distance between a position of the first target object and the virtual position.

6. The information processing device according to claim 2,
wherein the output control unit selects a characteristic of the wavefront synthesis filter according to the virtual position.

7. The information processing device according to claim 6,
wherein the output control unit selects a characteristic of the wavefront synthesis filter according to a relationship among a position of the first upper speaker array, a position of the first lower speaker array, and the virtual position.

8. The information processing device according to claim 7,
wherein the output control unit selects a characteristic of a band emphasis filter according to a position in an up-down direction of the virtual position with respect to the first upper speaker array and the first lower speaker array.

9. The information processing device according to claim 2,
wherein the output control unit selects a characteristic of the wavefront synthesis filter according to position information of each of a plurality of the first target objects in a case where there is the plurality of the first target objects.

10. The information processing device according to claim 9,
wherein the output control unit selects a characteristic of the wavefront synthesis filter such that an average position of a plurality of the first target objects is included in a sound image localization service area.

11. The information processing device according to claim 9,
wherein the output control unit selects a characteristic of the wavefront synthesis filter such that the number of the first target objects included in a sound image localization service area increases.

12. The information processing device according to claim 1,
wherein in a case where there is a plurality of the second target objects,
the position determination processing unit determines the virtual position for each of the plurality of the second target object, and
the output control unit selects a characteristic of the wavefront synthesis filter for each of a plurality of the virtual positions.

13. The information processing device according to claim 1,
wherein the first target object is a head of a person.

14. The information processing device according to claim 1,
wherein the position determination processing unit performs correction processing for the virtual position in a case where a distance between the first target object and the virtual position in the first fusion space is less than a predetermined value.

15. The information processing device according to claim 1,
wherein the position information acquisition unit obtains position information of the first target object on a basis of an output from a stereo camera.

16. The information processing device according to claim 1,
wherein the position determination processing unit determines the virtual position on a basis of a difference in a size of the second space and a size of the first space.

17. An information processing method in which an arithmetic processing device performs:
a process of acquiring position information of a first target object in a first space in which a speaker array is arranged and position information of a second target object in a second space;
a process of determining a virtual position of the second target object in a first fusion space obtained by virtually fusing the second space to the first space; and
a process of performing output control of the speaker array by applying a wavefront synthesis filter to a signal obtained by collecting a sound emitted from the second target object such that a sound image is localized at the virtual position.

18. A storage medium storing a program for causing an arithmetic processing device to perform:
a process of acquiring position information of a first target object in a first space in which a speaker array is arranged and position information of a second target object in a second space;
a process of determining a virtual position of the second target object in a first fusion space obtained by virtually fusing the second space to the first space; and
a process of performing output control of the speaker array by applying a wavefront synthesis filter to a signal obtained by collecting a sound emitted from the second target object such that a sound image is localized at the virtual position.
